(19) United States
(12) Patent Application Publication
(10) Pub. No.: US 2026/0253390 A1
(43) Pub. Date: Aug. 27, 2026

(54) HIERARCHICAL VISION ENCODING ENABLED COGNITIVE ANALYSIS

(71) Applicant: QUALCOMM Incorporated, San Diego, CA (US)

(72) Inventors: Titash RAKSHIT, Austin, TX (US); Munawar HAYAT, San Diego, CA (US); Fatih Murat PORIKLI, San Diego, CA (US)

(21) Appl. No.: 19/543,547

(22) Filed: Feb. 18, 2026

Related U.S. Application Data
(60) Provisional application No. 63/764,173, filed on Feb. 27, 2025.

(51) Int. Cl. G06V 10/77; G06V 10/82; G06V 10/94; G06F 40/40

(52) U.S. Cl. CPC G06V 10/77; G06V 10/82; G06V 10/94; G06F 40/40

(57) ABSTRACT

A glasses device includes a memory configured to store one or more sets of image latent data. The glasses device also includes one or more processors coupled to the memory and configured to process, at a hierarchical vision encoder (HVE), a first image frame of a sequence of image frames to generate first image latent data, wherein the first image latent data corresponds to a downscaled representation of the first image frame. The one or more processors are also configured to add the first image latent data to image analysis data used to represent the sequence of image frames for image-based cognitive analysis.

### I. CROSS-REFERENCE TO RELATED APPLICATIONS

The present application claims priority from Provisional Patent Application No. 63/764,173, filed February 27, 2025, and entitled “HIERARCHICAL VISION ENCODING ENABLED COGNITIVE ANALYSIS,” which is incorporated herein by reference in its entirety.

### II. FIELD

The present disclosure is generally related to hierarchical vision encoding enabled cognitive analysis.

### III. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to capture image frames from a camera. The image frames can be used as input for further analysis, such as generating responses to image-related queries. A computing device typically has limited storage capacity that restricts the number of image frames that can be retained for later use. Transmitting the image frames to another device that may have more storage capacity for analysis can use significant bandwidth.

### IV. SUMMARY

According to one implementation of the present disclosure, a glasses device includes a memory configured to store one or more sets of image latent data. The glasses device also includes one or more processors coupled to the memory and configured to process, at a hierarchical vision encoder (HVE), a first image frame of a sequence of image frames to generate first image latent data, wherein the first image latent data corresponds to a downscaled representation of the first image frame. The one or more processors are also configured to add the first image latent data to image analysis data used to represent the sequence of image frames for image-based cognitive analysis.

According to another implementation of the present disclosure, a companion device includes a memory configured to store one or more sets of image latent data. The companion device also includes one or more processors coupled to the memory and configured to receive, from a hierarchical vision encoder (HVE) of a glasses device, first image latent data corresponding to a downscaled representation of a first image frame of a sequence of image frames. The one or more processors are also configured to use a multimodal transformer network to perform image-based cognitive analysis based on the first image latent data to generate a response.

According to another implementation of the present disclosure, a method includes processing, at a hierarchical vision encoder (HVE) of a glasses device, a first image frame of a sequence of image frames to generate first image latent data, wherein the first image latent data corresponds to a downscaled representation of the first image frame. The method also includes adding the first image latent data to image analysis data used to represent the sequence of image frames for image-based cognitive analysis.

According to another implementation of the present disclosure, a method includes receiving, at a companion device from a hierarchical vision encoder (HVE) of a glasses device, first image latent data corresponding to a downscaled representation of a first image frame of a sequence of image frames. The method also includes using a multimodal transformer network to perform image-based cognitive analysis based on the first image latent data to generate a response.

According to another implementation of the present disclosure, a non-transitory computer-readable medium stores instructions that, when executed by one or more processors, cause the one or more processors to process, at a hierarchical vision encoder (HVE) of a glasses device, a first image frame of a sequence of image frames to generate first image latent data, wherein the first image latent data corresponds to a downscaled representation of the first image frame. The instructions further cause the one or more processors to add the first image latent data to image analysis data used to represent the sequence of image frames for image-based cognitive analysis.

According to another implementation of the present disclosure, a non-transitory computer-readable medium stores instructions that, when executed by one or more processors, cause the one or more processors to receive, at a companion device from a hierarchical vision encoder (HVE) of a glasses device, first image latent data corresponding to a downscaled representation of a first image frame of a sequence of image frames. The instructions further cause the one or more processors to use a multimodal transformer network to perform image-based cognitive analysis based on the first image latent data to generate a response.

According to another implementation of the present disclosure, an apparatus includes means for processing, at a hierarchical vision encoder (HVE) of a glasses device, a first image frame of a sequence of image frames to generate first image latent data, wherein the first image latent data corresponds to a downscaled representation of the first image frame. The apparatus further includes means for adding the first image latent data to image analysis data used to represent the sequence of image frames for image-based cognitive analysis.

According to another implementation of the present disclosure, an apparatus includes means for receiving, at a companion device from a hierarchical vision encoder (HVE) of a glasses device, first image latent data corresponding to a downscaled representation of a first image frame of a sequence of image frames. The apparatus further includes means for using a multimodal transformer network to perform image-based cognitive analysis based on the first image latent data to generate a response.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1A is a block diagram of a particular illustrative example of a system operable to perform hierarchical vision encoding enabled cognitive analysis, in accordance with some examples of the present disclosure.

FIG. 1B is a diagram of an illustrative example of a hierarchical vision encoder, in accordance with some examples of the present disclosure.

FIG. 2 is a diagram of another illustrative example of a system operable to perform hierarchical vision encoding enabled cognitive analysis, in accordance with some examples of the present disclosure.

FIG. 3 is a diagram of an illustrative example of an image-based cognitive analyzer, in accordance with some examples of the present disclosure.

FIG. 4 illustrates an example of an integrated circuit operable to perform hierarchical vision encoding enabled cognitive analysis, in accordance with some examples of the present disclosure.

FIG. 5 is a diagram of a mixed reality or augmented reality glasses device operable to perform hierarchical vision encoding enabled cognitive analysis, in accordance with examples of the present disclosure.

FIG. 6 is a diagram of the glasses of FIG. 5 and a mobile device operable to perform hierarchical vision encoding enabled cognitive analysis, in accordance with some examples of the present disclosure.

FIG. 7 is a diagram of the glasses of FIG. 5 and a wearable electronic device operable to perform hierarchical vision encoding enabled cognitive analysis, in accordance with some examples of the present disclosure.

FIG. 8 is a diagram of the glasses of FIG. 5 and a voice-controlled speaker system operable to perform hierarchical vision encoding enabled cognitive analysis, in accordance with some examples of the present disclosure.

FIG. 9 is a diagram of a headset, such as a virtual reality, mixed reality, or augmented reality headset, operable to perform hierarchical vision encoding enabled cognitive analysis, in accordance with some examples of the present disclosure.

FIG. 10 is a diagram of the glasses of FIG. 5 and an example of a vehicle operable to perform hierarchical vision encoding enabled cognitive analysis, in accordance with some examples of the present disclosure.

FIG. 11 is a diagram of a particular implementation of a method of performing hierarchical vision encoding enabled cognitive analysis that may be performed by the devices of FIGS. 1A and 2, in accordance with some examples of the present disclosure.

FIG. 12 is a diagram of a particular implementation of a method of performing hierarchical vision encoding enabled cognitive analysis that may be performed by a device of FIG. 2, in accordance with some examples of the present disclosure.

FIG. 13 is a block diagram of a particular illustrative example of a device that is operable to perform hierarchical vision encoding enabled cognitive analysis, in accordance with some examples of the present disclosure.

### VI. DETAILED DESCRIPTION

Cognitive analysis can be performed on image frames, such as to generate responses to image-related queries. Limited storage capacity at a device can restrict the number of image frames that can be stored and made available for further analysis. Transmitting the image frames to another device that may have more storage capacity for analysis can use significant bandwidth.

Systems and methods of hierarchical vision encoding enabled cognitive analysis are disclosed. For example, a hierarchical vision encoder (HVE) processes an image frame to generate image latent data that represents the image frame for cognitive analysis. To illustrate, using a first stage of the HVE, an image frame is processed to generate first image latent data that corresponds to a first downscaled representation of the image frame. A second stage of the HVE processes the first image latent data to generate second image latent data that corresponds to a second downscaled representation of the image frame. For example, the second downscaled representation corresponds to additional downscaling of the first downscaled representation. Each subsequent stage of the HVE processes previous image latent data generated by a prior stage of the HVE to generate image latent data that corresponds to an additionally downscaled representation of the image frame. In an example, the HVE includes a convolutional neural network (CNN) and each stage of the HVE corresponds to a respective convolutional layer of the CNN.

The image latent data is added to image analysis data stored in a memory. Subsequently, when cognitive analysis based on the image frame is to be performed, the image latent data representing the image frame is retrieved from the memory and cognitive analysis is performed on the image latent data to generate a response to an image-related query.

The image latent data has a smaller size than the original image frame. For example, fewer bits are used to store the image latent data in the memory than bits that would be used to store the original image frame. Therefore, image latent data corresponding to a greater number of image frames can be stored in the memory more efficiently than storing the image frames themselves. Consequently, data from a greater number of image frames becomes accessible for cognitive analysis.

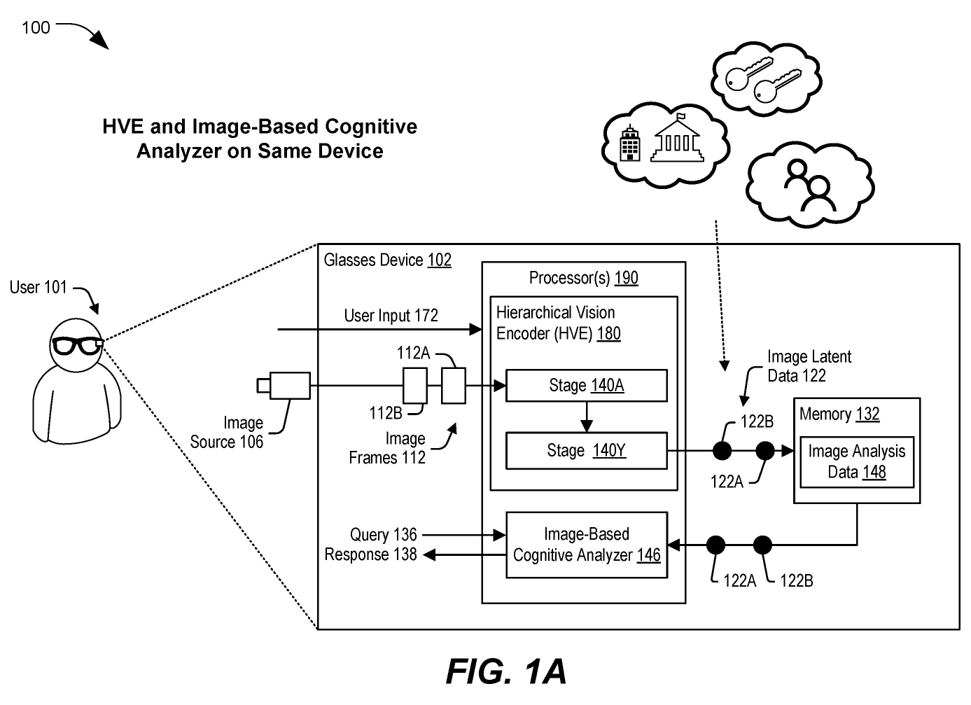

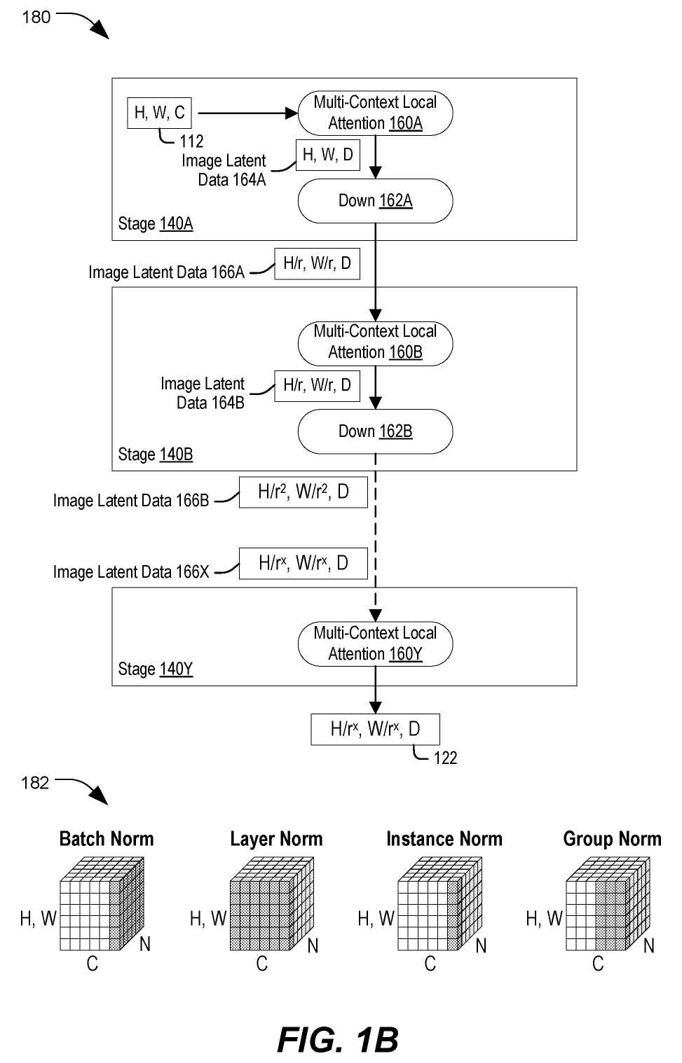

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1A depicts a glasses device 102 including one or more processors (“processor(s)” 190 of FIG. 1A), which indicates that in some implementations the glasses device 102 includes a single processor 190 and in other implementations the glasses device 102 includes multiple processors 190. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1A, multiple image frames are illustrated and associated with reference numbers 112A and 112B. When referring to a particular one of these image frames, such as an image frame 112A, the distinguishing letter “A” is used. However, when referring to any arbitrary one of these image frames or to these image frames as a group, the reference number 112 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, receiving, or accessing the parameter (or signal) that is already generated, such as by another component or device.

As used herein, the term “latent data” should be understood in accordance with any of its usual and customary meanings in the fields of computer science, data science, and/or machine learning. For example, latent data can be generated by a machine-learning model as a representation of data input to the machine-learning model. Generally, the latent data include values representing underlying patterns, structures, or features that the machine-learning model infers from the input data. Ideally, the latent data represents the input data in a manner that includes important and/or unique characteristics of the input data in view of a goal or purpose of the machine-learning model. To illustrate, image latent data described herein includes latent data representing characteristics of one or more images in a manner that is useful for image-based cognitive analysis.

As used herein, the term “hierarchical vision encoder” should be understood in accordance with any of its usual and customary meanings in the fields of computer science, data science, and/or machine learning. Generally, a hierarchical vision encoder corresponds to an encoder that includes at least two stages and is configured to process image data in a hierarchical manner (e.g., output of one stage is provided as input, possibly along with other data, to a subsequent stage). To illustrate, a hierarchical vision encoder described herein includes at least a first stage and a second stage. The first stage is configured to process image data of an image frame to generate first stage output (e.g., image latent data) corresponding to a representation (e.g., a downscaled representation) of the image frame. The second stage is configured to process the first stage output (e.g., the image latent data) to generate second stage output corresponding to a representation (e.g., an additionally downscaled representation) of the image frame.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows – a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

Referring to FIG. 1A, a particular illustrative aspect of a system configured to perform hierarchical vision encoding enabled cognition analysis is disclosed and generally designated 100. The system 100 includes a glasses device 102 that includes one or more processors 190 coupled to a memory 132. The one or more processors 190 are also coupled to an image source 106. The one or more processors 190 include a hierarchical vision encoder (HVE) 180 and an image-based cognitive analyzer 146. The HVE 180 is coupled to the memory 132. The memory 132 is also coupled to the image-based cognitive analyzer 146.

The image source 106 is depicted as a video camera external to the glasses device 102 as an illustrative example, in some other examples, the image source 106 can be integrated into the glasses device 102. In some examples, the image source 106 can include various types of image sources, such as a still camera, a synthetic image generation device (e.g., a graphical processing unit (GPU)), a network device, a storage device, a communication device, or a combination thereof. The image source 106 is configured to provide a sequence of image frames 112 to the one or more processors 190. In a particular aspect, the sequence of image frames 112 includes an image frame 112A, an image frame 112B, one or more additional image frames, or a combination thereof.

The HVE 180 is configured to process an image frame 112 to generate image latent data 122 that corresponds to a downscaled representation of the image frame 112, as further described with reference to FIG. 1B. In an example, the HVE 180 includes a plurality of stages, such as a stage 140A, a stage 140Y, one or more additional stages, or a combination thereof. The stage 140A is configured to process an image frame 112 to generate image latent data corresponding to a downscaled representation of the image frame 112. Each subsequent stage 140 is configured to process previous image latent data generated by a prior stage 140 to generate subsequent image latent data. The previous image latent data corresponds to a representation of a previous image frame (e.g., a downscaled version of the image frame 112) and the subsequent image latent data corresponds to a downscaled representation of the previous image frame (e.g., an additionally downscaled version of the image frame 112). The stage 140Y is configured to process image latent data generated by a prior stage 140 to generate the image latent data 122. Optionally, in some embodiments, the HVE 180 includes a convolutional neural network (CNN), and a particular convolutional layer of the CNN corresponds to a respective stage 140 of the HVE 180. The image latent data 122 represents the image frames 112. In some examples, an image frame 112 can depict sensitive information, people, homes, offices, etc., and storing or transmitting the image latent data 122 instead of the image frames 112 enhances security.

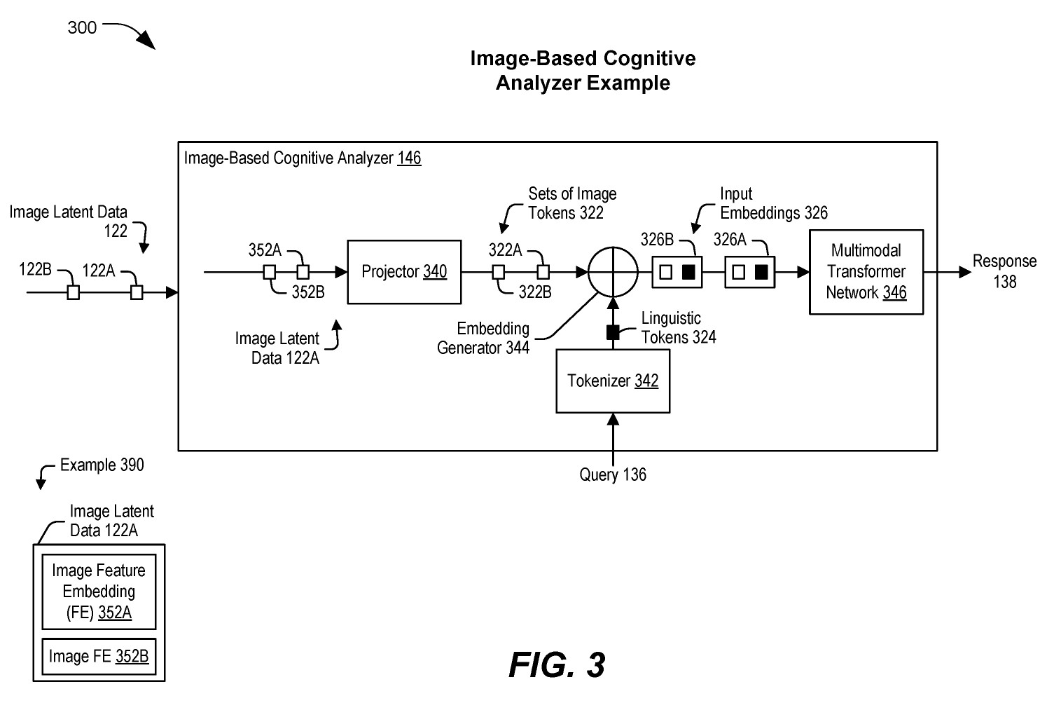

The image-based cognitive analyzer 146 is configured to use image latent data 122 to perform image-based cognitive analysis. For example, the image-based cognitive analyzer 146 is configured to process image latent data 122 of one or more image frames 112 to generate a response 138 to a query 136, as further described with reference to FIG. 3. To illustrate, the image-based cognitive analyzer 146 is configured to generate image tokens based on the image latent data 122, generate linguistic tokens based on the query 136, generate an input embedding based on the image tokens and the linguistic tokens, and use a large language model (LLM) to process the input embedding to generate the response 138.

The memory 132 is configured to store data used or generated by one or more components of the glasses device 102. For example, the memory 132 is configured to store one or more of an image frame 112, image latent data 122 corresponding to a representation (e.g., a downscaled representation) of the image frame 112, image analysis data 148 used to represent the sequence of image frames 112 for image-based cognitive analysis, the query 136, the response 138, or additional data. In some aspects, the memory 132 includes an image buffer, a data transmission buffer, a data receipt buffer, or a combination thereof.

In some embodiments, the glasses device 102 corresponds to or is included in one of various types of devices. In some examples, the one or more processors 190 are integrated in a mixed reality or augmented reality glasses device, as further described with reference to FIG. 5, or a virtual reality, mixed reality, or augmented reality headset, as further described with reference to FIG. 9.

During operation, the image source 106 (e.g., a phone camera) of a user 101 provides an image frame 112A of a sequence of image frames 112 to the HVE 180. The HVE 180 processes, using the stages 140, the image frame 112A to generate image latent data 122A corresponding to a representation (e.g., a downscaled representation) of the image frame 112A. Optionally, in some embodiments, the HVE 180, subsequent to processing the image frame 112A to generate the image latent data 122A, discards the image frame 112A. To illustrate, the image frame 112A is stored in the memory 132 (e.g., an image buffer) and the HVE 180 marks the image frame 112A for deletion from the memory 132.

Optionally, in some embodiments, the HVE 180 corresponds to a CNN that includes one or more convolutional layers (e.g., 5 convolutional layers), one or more pooling layers, one or more fully connected layers, a softmax layer, or a combination thereof. As one example, the image frame 112A can include data representing a set of pixels (e.g., 768 x 768 pixels), where each pixel represents multiple color channels, such as red, green, blue (RGB). In this example, the image frame 112A can be processed using the CNN of the HVE 180 to generate the image latent data 122A. The image latent data 122A can include a set of image feature embeddings (e.g., 144 image feature embeddings), where each image feature embedding includes a vector or array of values (e.g., a 512-dimensional feature vector). In some examples, one or more layers (e.g., convolutional layers) of the CNN correspond to downscaling operations (e.g., downscaling stages 140), and the image latent data 122A corresponds to a downscaled representation of the image frame 112A. It should be understood that a CNN is provided as an illustrative example of the HVE 180, in other examples the HVE 180 can include other types of neural networks, procedural operations, or a combination thereof, to generate the image latent data 122A that corresponds to a representation (e.g., a downscaled representation) of the image frame 112A.

The HVE 180 adds the image latent data 122A to image analysis data 148 used to represent the sequence of image frames for image-based cognitive analysis. In a particular aspect, the image latent data 122A is designated as associated with (e.g., representative of) the image frame 112A. In an example, the image latent data 122A is designated as associated with a timestamp of the image frame 112A, a location of the image source 106 when the image frame 112A is captured, a user identifier of a user 101 that is logged into the glasses device 102 when the image frame 112A is obtained, or a combination thereof. The image analysis data 148 is stored in the memory 132.

In some aspects, the HVE 180 performs similar operations to process additional image frames of the sequence of image frames 112 to generate corresponding sets of image latent data 122. For example, the HVE 180 obtains the image frame 112B from the image source 106 and processes the image frame 112B to generate image latent data 122B. To illustrate, the stages 140 of the HVE 180 process the image frame 112B to generate image latent data 122B. Optionally, in some embodiments, the HVE 180, subsequent to processing the image frame 112B to generate the image latent data 122B, discards the image frame 112B. The HVE 180 adds the image latent data 122B to the image analysis data 148.

A set of image latent data 122 is smaller than a corresponding image frame 112. For example, the image latent data 122A has a first size that is smaller than a second size of the image frame 112A. In an example, the image latent data 122A includes a set of image feature embeddings and the image frame 112A includes a set of pixels. In this example, the image latent data 122A has a first size that is based on the count of image feature embeddings and an image feature embedding size, and the image frame 112A has a second size that is based on a count of pixels and a pixel size. To illustrate, the first size (e.g., 288 kilobytes (KB)) of the image latent data 122A = image feature embedding count (e.g., 144 image feature embeddings) x image feature embedding size (e.g., 512-dimensional vector x 32 bits per dimension = 2 KB). The second size (e.g., 1,769,472 bytes or 1.69 megabytes (MB)) = pixel count (e.g., 768x768 pixels = 589,824 pixels) x pixel size (e.g., 3 bytes/pixel). Hence, a count of bits (e.g., 288 KB) used to store the image latent data 122A in the memory 132 is less than a count of bits (e.g., 1.69 MB) that would be used to store the image frame 112A in the memory 132.

It should be understood that particular values are provided as illustrative examples, in some other examples other values can be used. For example, 3 bytes/pixel is used as an illustrative example of pixel size (e.g., an RGB pixel size of 3 bytes); in some other examples a pixel can have another size. As another example, particular dimensions (e.g., 768 x 768 pixels) of an image frame are used as an illustrative example; in some other examples an image frame can have other dimensions. A particular image feature embedding count (e.g., 144 image feature embeddings) is provided as an illustrative example; in some other examples the image latent data 122A can include another count of image feature embeddings. A particular image feature embedding size (e.g., 288 KB) is provided as an illustrative example; in some other examples an image feature embedding can have another size.

A video with a particular frame rate typically has a corresponding count of image frames 112 in an hour of video. For example, an hour of video with a particular frame rate (e.g., 1 frame/second) corresponds to an hourly image frame count (e.g., 1 frame/second x 3600 seconds/hour = 3600 frames/hour). The sets of image latent data 122 corresponding to an hour of video have an hourly set size that is based on the hourly image frame count and a size of a set of image latent data 122 of an image frame 112. For example, the hourly set size (e.g., 1,036,800 KB/hour ≈ 0.97 gigabytes (GB)/hour) = hourly image frame count (e.g., 3600 image frames/hour) x image feature embedding set size (e.g., 288 KB/image frame). With a pre-determined memory capacity to store the image analysis data 148, sets of image latent data 122 of a video having up to a particular length can be stored. The particular length is based on the memory capacity and the hourly set size. For example, particular length (e.g., 4.1 hours) = memory capacity (e.g., 4 GB) ÷ hourly set size (e.g., 0.97 GB/hour).

Subsequently, the image-based cognitive analyzer 146 receives a query 136 related to the sequence of image frames 112. In a particular aspect, the image-based cognitive analyzer 146 receives, from a user 101, user input 172 indicating the query 136. In some aspects, the query 136 indicates a set of image frames 112 of interest. For example, the query 136 (e.g., “where did I leave my keys in the last one hour?”) indicates a target time interval (e.g., captured in the last one hour) of the set of image frames 112 of interest. The image-based cognitive analyzer 146, based on determining that the query 136 is associated with one or more image frames 112, retrieves latent data from the image analysis data 148 corresponding to the one or more image frames 112. For example, the image-based cognitive analyzer 146, based on determining that query 136 is associated with the image frame 112A, retrieves the image latent data 122A from the image analysis data 148 corresponding to the image frame 112A.

The image-based cognitive analyzer 146 performs image-based cognitive analysis based on the image latent data 122A to generate a response 138 to the query 136, as further described with reference to FIG. 3. The image-based cognitive analysis includes processing linguistic inputs and image-based inputs using a multimodal transformer network. For example, the image-based cognitive analyzer 146 generates image tokens based on the image latent data 122A and linguistic tokens based on the query 136, generates an input embedding based on the image tokens and the linguistic tokens, uses a multimodal transformer network (e.g., an LLM) to perform image-based cognitive analysis based on the input embedding to generate the response 138. The response 138 can include text, audio, or both. If the response 138 corresponds to an answer to the query 136 that is identified in the image frame 112A, the response 138 can indicate image-related data associated with the image latent data 122A. For example, if the response 138 indicates that a queried object (e.g., the key) was most recently detected in the image frame 112A, the response 138 can indicate a time, a location, a user, or a combination thereof associated with the image latent data 122A. In a particular aspect, the image-based cognitive analyzer 146 outputs the response 138 to the user 101. In an example, the image-based cognitive analyzer 146 provides the response 138 to a display device, a communication device, a speaker, or a combination thereof.

A technical advantage of the system 100 includes accessibility to data associated with more image frames 112 for cognitive analysis. For example, the image latent data 122A is smaller than the image frame 112A. With limited storage capacity, sets of image latent data 122 corresponding to more image frames 112 can be stored in the memory 132 than original image frames 112.

In some examples, based on an output of the HVE 108, the image-based cognitive analyzer 146, a neural network, a machine-learning model, or a combination thereof, one or more components of a device (e.g., the glasses device 102) can perform various operations such as: i) controlling a machine such as a vehicle, a robot, an appliance, a mobile device, a camera; ii) controlling an actuator such as an electromechanical actuator, an electrohydraulic actuator, an electroactive polymer actuator; iii) controlling an active circuit component such as a voltage or current source, a transistor, an amplifier, an integrated circuit, a programmable device such as field-programmable gate array (FPGA), a display device; iii) providing a notification to a user, such as a visual, auditory or haptic notification or combination thereof, iv) launching, closing, pausing or suspending an application on a computer; iv) launching, closing, pausing or suspending playback of audio video (AV) media on a computer; or v) providing a control signal to initiate any of the above.

Referring to FIG. 1B, an illustrative example of the HVE 180 is disclosed, in accordance with some examples of the present disclosure. The HVE 180 includes a plurality of stages 140, such as a stage 140A, a stage 140B, one or more additional stages 140, a stage 140Y, or a combination thereof. It should be understood that the HVE 180 is depicted as including 3 stages 140 as an illustrative example; in other examples the HVE 180 can include fewer than 3 or more than 3 stages 140.

Each stage 140 of the HVE 180 includes a multi-context local attention 160. For example, the stage 140A includes a multi-context local attention 160A, the stage 140B includes a multi-context local attention 160B, the stage 140Y includes a multi-context local attention 160Y, and so on. One or more of the stages 140 of the HVE 180 include a downscaling layer 162 (e.g., a pooling layer or a convolution layer). For example, the stage 140A includes a downscaling layer 162A, the stage 140B includes a downscaling layer 162B, and so on. In some embodiments, the last stage (e.g., the stage 140Y) does not include a downscaling layer 162.

The multi-context local attention 160A processes data representing an image frame 112 to generate image latent data 164A. In an example, a multi-context local attention 160 is configured to capture dependencies across different parts of an input. To illustrate, the multi-context local attention 160 performs feature extraction by integrating contextual information to generate image latent data 164.

The image frame 112 has a height (H), a width (W), and channels (C). The image latent data 164A includes first image feature embeddings representing the image frame 112 having the height (H) and the width (W). An image feature embedding has an embedding dimension (D) that indicates a count of features (e.g., numerical values) represented in the image feature embedding.

The downscaling layer 162A processes the image latent data 164A to generate image latent data 166A. The image latent data 166A includes second image feature embeddings that represent a downscaled representation of the image frame 112. For example, the downscaled representation has a height (H/r) and a width (W/r), where r corresponds to a downscaling factor. In some embodiments, a second image feature embedding of image latent data 166 has the same dimensionality (D) as a first image feature embedding of image latent data 164. In some embodiments, a count of the second image feature embeddings included in the image latent data 166 that is output by a downscaling layer 162 is fewer than a count of the first image feature embeddings included in the image latent data 164 input to the downscaling layer 162.

Optionally, in some embodiments, similar operations are performed at one or more intermediate stages 140 of the HVE 180 based on output of respective previous stages 140. For example, the multi-context local attention 160B processes the image latent data 166A to generate image latent data 164B. The downscaling layer 162B processes the image latent data 164B to generate image latent data 166B. The image latent data 166B includes third image feature embeddings that represent a downscaled representation of the image frame 112. For example, the downscaled representation has a height (H/r²) and a width (W/r²), where each of the downscaling layers 162A and 162B have the same downscaling factor (r). To illustrate, the third image feature embeddings of the image latent data 166B correspond to a downscaled representation of an image frame represented by the second image frame embeddings of the image latent data 166A. In some embodiments, a count of the third image feature embeddings included in the image latent data 166B that is output by the downscaling layer 162B is fewer than a count of the second image feature embeddings included in the image latent data 166A that is output by the downscaling layer 162A.

At the stage 140Y (e.g., a last stage of the stages 140), the multi-context local attention 160B processes the image latent data 166X (e.g., image latent data 166 generated by a previous stage 140) to generate the image latent data 122. The image latent data 122 corresponds to a downscaled representation of the image frame 112. In some aspects, the downscaled representation has a height (H/r^{x}) and a width (W/r^{x}), where x is a count of stages prior to the stage 140Y. In an example, the image latent data 122 includes fourth image feature embeddings, and each image feature embedding has an embedding dimension (D). In some aspects, a count of the fourth image feature embeddings of the image latent data 122 is fewer than a count of the first image feature embeddings of the image latent data 164A. For example, the fourth image feature embeddings correspond to a downscaled representation (e.g., an image frame having a height (H/r^{x}) and a width (W/r^{x})) as compared to the first image frame embeddings corresponding to the image frame 112 (e.g., having a height (H) and a width (W)).

It should be understood that a stage 140 can include one or more additional layers or components that are not shown, such as one or more of a normalization layer, a convolution layer, a pooling layer, etc. In an example 182, various types of normalizations are depicted, such as batch normalization, layer normalization, instance normalization, and group normalization. Height (H) and width (W) correspond to spatial dimensions of an image frame 112, C corresponds to channels in the image frame 112, and N corresponds to a batch size.

A technical advantage of the HVE 180 includes retaining characteristics of the image frames 112 in the image latent data 122 with a reduced size, as compared to the original image frame 112 and also as compared to the image latent data 164A. The smaller size of the image latent data 122 enables conservation of resources (e.g., memory, bandwidth, or both).

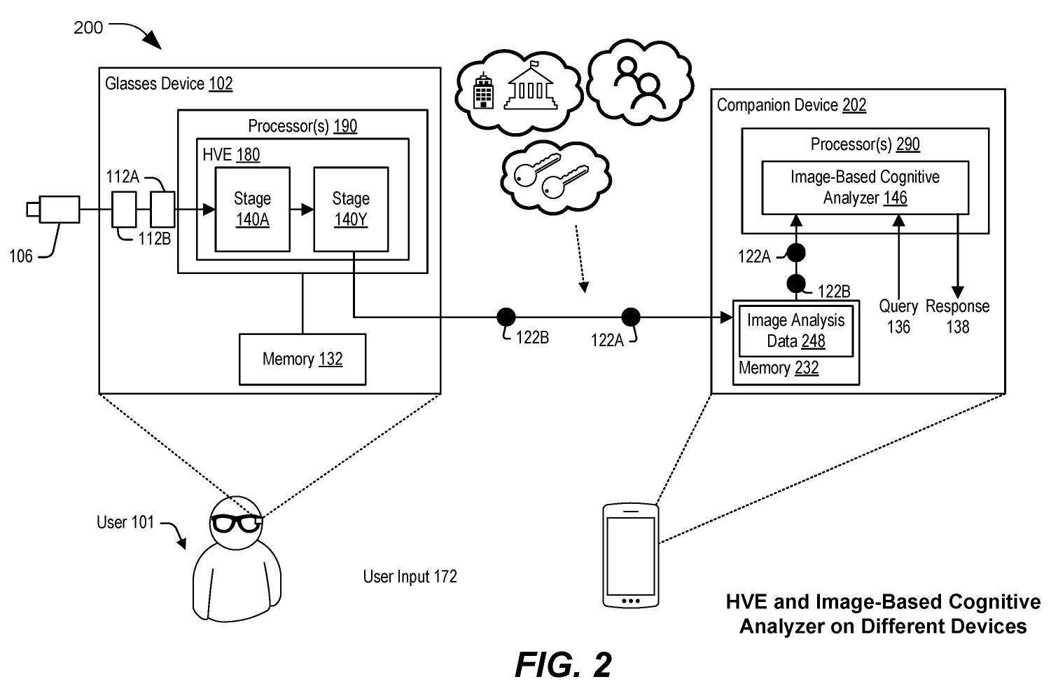

Referring to FIG. 2, a particular illustrative aspect of a system configured to perform hierarchical vision encoding enabled cognitive analysis is disclosed and generally designated 200, in accordance with some examples of the present disclosure. The system 200 includes the glasses device 102 coupled to one or more companion devices 202.

A companion device 202 includes one or more processors 290 coupled to a memory 232. The memory 232 is configured to store data used or generated by one or more components of the companion device 202. The image-based cognitive analyzer 146 is included in the one or more processors 290 of the companion device 202. The HVE 180 is included in the one or more processors 190 of the glasses device 102. In some examples, the companion device 202 (e.g., a phone, a gaming system, a network device, a server, or a combination thereof) includes more storage capacity, more computing resources, or both, than the glasses device 102.

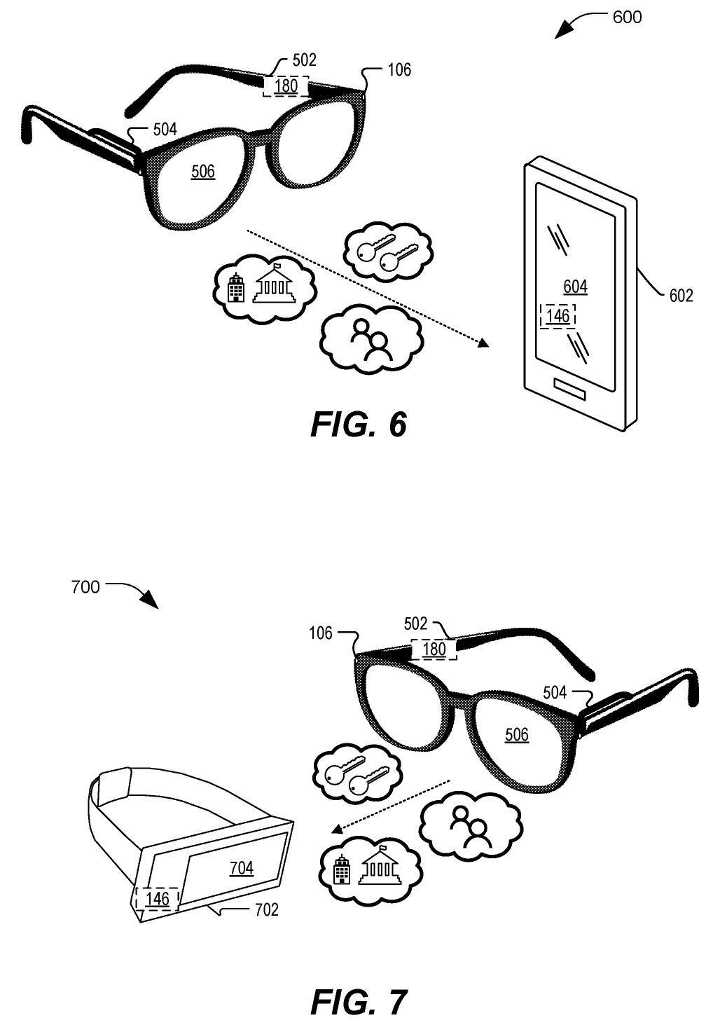

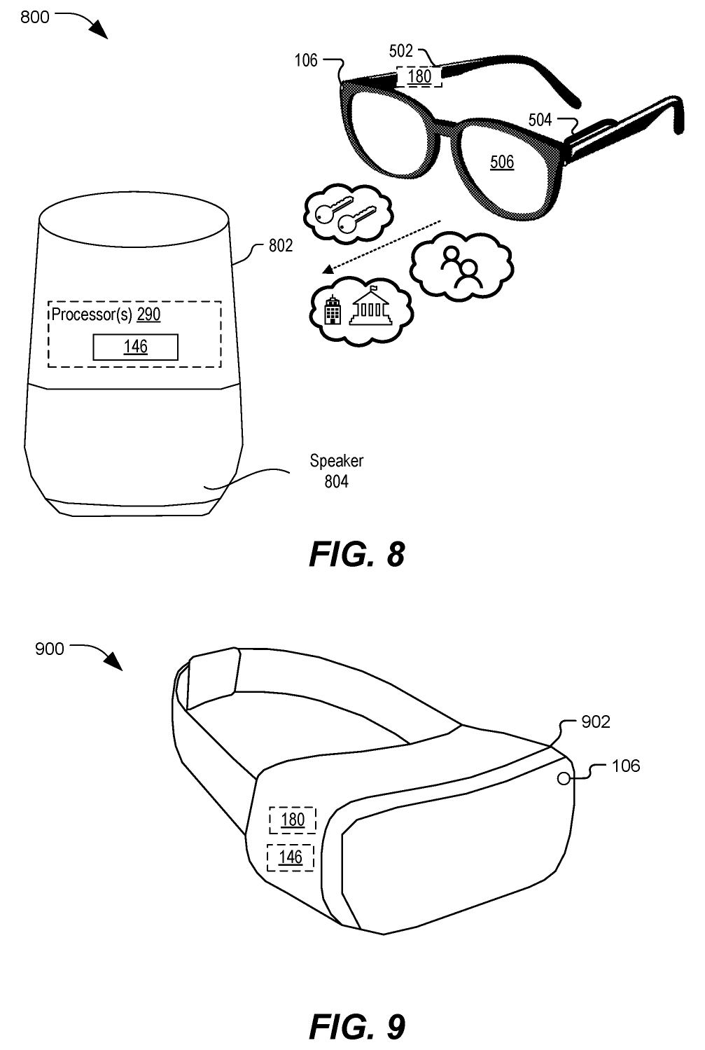

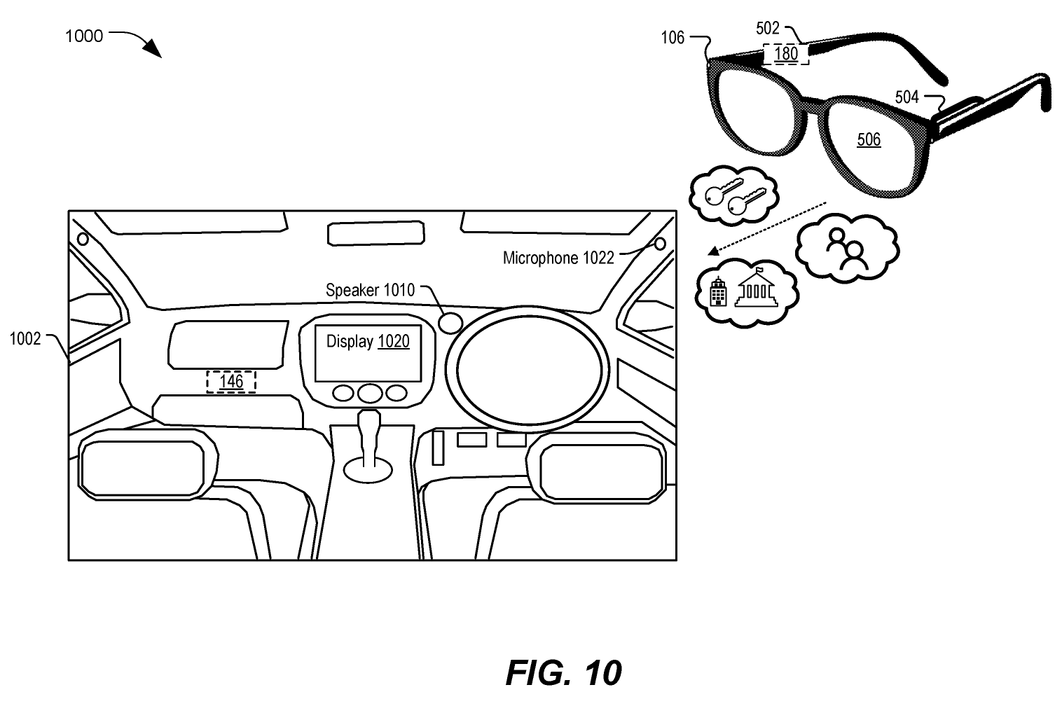

In a non-limiting illustrative example, the one or more processors 190 are integrated in a mixed reality or augmented reality glasses device, and the one or more processors 290 are integrated in at least one of a mobile phone or a tablet computer device, as further described with reference to FIG. 6, a wearable electronic device, as described with reference to FIG. 7, a voice-controlled speaker system, as described with reference to FIG. 8, or a vehicle, as described with reference to FIG. 10.

During operation, the HVE 180 processes the image frame 112A to generate the image latent data 122A, as described with reference to FIG. 1A. The HVE 180 adds the image latent data 122A to image analysis data 248 used to represent the sequence of image frames 112 for image-based cognitive analysis. For example, the HVE 180 initiates transmission of the image latent data 122A to one or more companion devices 202.

The companion device 202 receives the image latent data 122A and adds the image latent data 122A to the image analysis data 248 stored in the memory 232. Subsequently, the image-based cognitive analyzer 146 of the companion device 202 retrieves the image latent data 122A from the memory 232, and processes the image latent data 122A to generate the response 138 to the query 136, as described with reference to FIGS. 1A and 3. For example, the image-based cognitive analyzer 146 generates image tokens based on the image latent data 122A, generates linguistic tokens based on the query 136, and uses an LLM to perform image-based cognitive analysis based on the image tokens and the linguistic tokens to generate the response 138.

A technical advantage of the system 200 includes offloading storage of the sets of image latent data 122 and performance of the image-based cognitive analysis from the glasses device 102 to the companion device 202. Hence, the glasses device 102 can be a relatively light-weight device, with the companion device 202 having more resources (e.g., more memory, computing resources, or both). Additionally, transmitting the image latent data 122 uses less bandwidth as compared to transmitting the original image frames 112. Hence, in conditions of limited network resources, image latent data 122 corresponding to more image frames 112 can be provided to the companion device 202 for the image-based cognitive analysis.

In some examples, based on an output of the HVE 108, the image-based cognitive analyzer 146, a neural network, a machine-learning model, or a combination thereof, one or more components of a device (e.g., the glasses device 102, the companion device 202, or both) can perform various operations such as: i) controlling a machine such as a vehicle, a robot, an appliance, a mobile device, a camera; ii) controlling an actuator such as an electromechanical actuator, an electrohydraulic actuator, an electroactive polymer actuator; iii) controlling an active circuit component such as a voltage or current source, a transistor, an amplifier, an integrated circuit, a programmable device such as FPGA, a display device; iii) providing a notification to a user, such as a visual, auditory or haptic notification or combination thereof, iv) launching, closing, pausing or suspending an application on a computer; iv) launching, closing, pausing or suspending playback of audio video (AV) media on a computer; or v) providing a control signal to initiate any of the above.

Referring to FIG. 3, an illustrative example 300 of the image-based cognitive analyzer 146 is disclosed, in accordance with some examples of the present disclosure. The image-based cognitive analyzer 146 includes a projector 340 and a tokenizer 342 that are each coupled to an embedding generator 344. The embedding generator 344 is coupled to a multimodal transformer network 346. In some aspects, the multimodal transformer network 346 corresponds to (e.g., includes) an LLM. In a particular aspect, the image-based cognitive analyzer 146 can be included in the glasses device 102 of FIG. 1A, the companion device 202 of FIG. 2, or both.

During operation, the tokenizer 342 processes the query 136 to generate linguistic tokens 324 that represent the query 136 in a token space. In an example, the tokenizer 342 breaks up the query 136 into linguistic segments, such as subwords, words, characters, other types of segments, or a combination thereof. The tokenizer 342 outputs linguistic tokens 324 (e.g., numerical values) corresponding to the linguistic segments. To illustrate, a linguistic token 324 (e.g., a numerical value) represents a corresponding linguistic segment in the token space.

The image-based cognitive analyzer 146 receives the image latent data 122A corresponding to the image frame 112A, as described with reference to FIGS. 1A and 2. In an example 390, the image latent data 122A includes an image feature embedding (FE) 352A, an image FE 352B, one or more additional image FEs, or a combination thereof, as described with reference to FIG. 1A. The projector 340 processes each image FE 352 to generate a corresponding set of image tokens 322. For example, the projector 340 processes the image FE 352A to generate a set of image tokens 322A, the image FE 352B to generate a set of image tokens 322B, and so on. A set of image tokens 322 represents a corresponding image FE 352 in a token space. In a particular aspect, the set of image tokens 322A and the linguistic tokens 324 are associated with the same token space and can be processed together by the multimodal transformer network 346.

The embedding generator 344 generates an input embedding 326A based on the set of image tokens 322A and the linguistic tokens 324. For example, the embedding generator 344 concatenates the set of image tokens 322A and the linguistic tokens 324 to generate the input embedding 326A. The multimodal transformer network 346 processes the input embedding 326A to generate the response 138. In a particular aspect, the response 138 includes a synthetic image, text, audio, or a combination thereof.

Similarly, the image-based cognitive analyzer 146 processes one or more additional image FEs 352 of the image latent data 122A associated with the image frame 112A and continues to generate (e.g., update) the response 138. For example, the projector 340 processes the image FE 352B to generate a set of image tokens 322B. The embedding generator 344 generates an input embedding 326B based on the set of image tokens 322B and the linguistic tokens 324. The multimodal transformer network 346 processes the input embedding 326B to generate (e.g., update) the response 138.

In a particular aspect, the image-based cognitive analyzer 146 processes image latent data 122 corresponding to one or more additional image frames 112 and continues to generate (e.g., update) the response 138. For example, the image-based cognitive analyzer 146 processes the image latent data 122B corresponding to the image frame 112B to generate (e.g., update) the response 138.

A technical advantage of the image-based cognitive analyzer 146 includes enabling generation of a response 138 to the query 136 based on the image latent data 122 that represents image features corresponding to downscaled representations of the image frames 112 without having access to the original image frames 112. For example, the HVE 180 of FIGS. 1A-2 can process an image frame 112A to generate the image latent data 122A and the image frame 112A can be discarded. The image latent data 122A is used to generate the response 138. Using the image latent data 122A instead of the original image frame 112A can conserve resources (e.g., bandwidth, memory, or both), as described with reference to FIGS. 1A and 2.

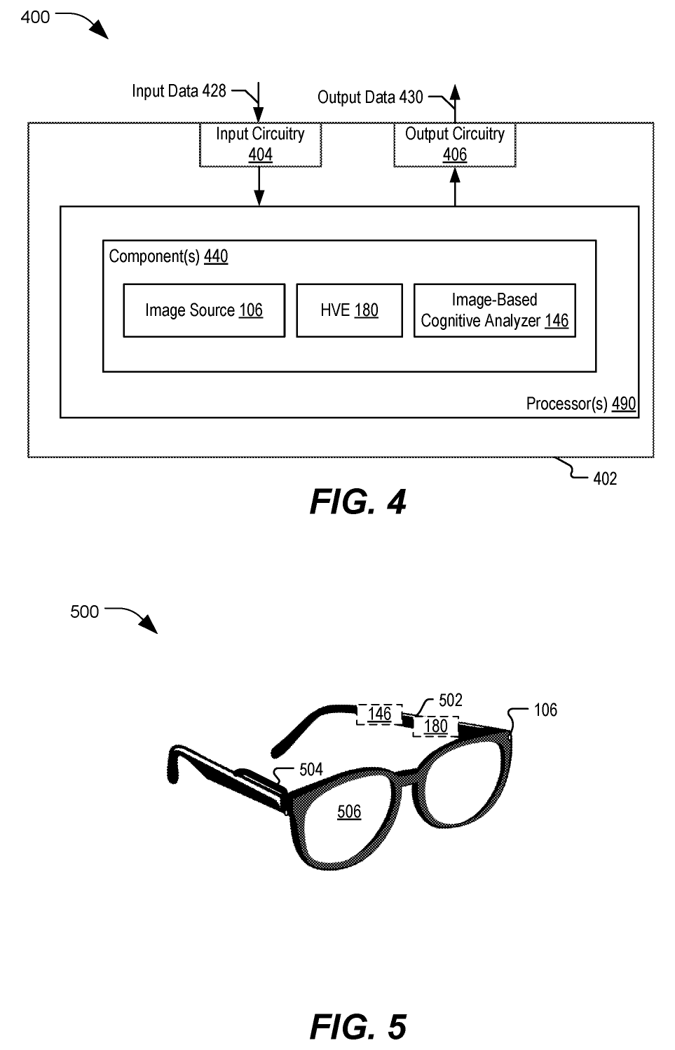

FIG. 4 depicts an implementation 400 of an integrated circuit 402 that includes one or more processors 490. In a particular aspect, the integrated circuit 402 corresponds to an implementation of the glasses device 102, the companion device 202, or both.

The one or more processors 490 include one or more components 440, such as the image source 106, the image-based cognitive analyzer 146 (e.g., the projector 340, the tokenizer 342, the embedding generator 344, the multimodal transformer network 346, or a combination thereof), the HVE 180 (e.g., the stages 140), or a combination thereof.

The integrated circuit 402 also includes input circuitry 404, such as one or more bus interfaces, to enable input data 428 to be received for processing. In a particular aspect, the input data 428 includes data used by one or more of the components 440, as described herein. For example, the input data 428 includes the sequence of image frames 112, the image latent data 122, the query 136, the user input 172, the image FEs 352, the sets of image tokens 322, the linguistic tokens 324, the input embeddings 326, or a combination thereof.

The integrated circuit 402 also includes output circuitry 406, such as a bus interface, to enable sending of output data 430. In a particular aspect, the output data 430 includes data generated by one or more of the components 440, as described herein. For example, the output data 430 includes the sequence of image frames 112, the image latent data 122, the response 138, the image FEs 352, the sets of image tokens 322, the linguistic tokens 324, the input embeddings 326, or a combination thereof.

The integrated circuit 402 enables implementation of hierarchical vision encoding enabled cognitive analysis as a component in a system, such as a mixed reality or augmented reality glasses device, as described with reference to FIG. 5, a mobile phone or tablet as depicted in FIG. 6, a wearable electronic device as depicted in FIG. 7, a voice-controlled speaker system as depicted in FIG. 8, a virtual reality, mixed reality, or augmented reality headset as depicted in FIG. 9, or a vehicle as depicted in FIG. 10.

FIG. 5 depicts an implementation 500 of a portable electronic device that corresponds to augmented reality or mixed reality glasses 502. In a particular aspect, the glasses 502 correspond to an implementation of the glasses device 102.

The glasses 502 include a holographic projection unit 504 configured to project visual data onto a surface of a lens 506 or to reflect the visual data off of a surface of the lens 506 and onto the wearer’s retina. The image-based cognitive analyzer 146, and optionally the image source 106, the HVE 180, or both, are integrated into the glasses 502. The glasses 502 perform one or more operations described with reference to the glasses device 102 of FIGS. 1A and 2. For example, the image source 106 may function to output the image frames 112, the HVE 180 may function to generate the image latent data 122, the image-based cognitive analyzer 146 may function to generate the response 138, or a combination thereof, as described with reference to FIGS. 1A and 2.

In a particular example, the holographic projection unit 504 is configured to display a notification based on obtaining the image frames 112, the image latent data 122, the query 136, the response 138, or a combination thereof. For example, the notification can be superimposed on the user’s field of view at a particular position that coincides with a location related to an answer indicated in the response 138.

FIG. 6 depicts the glasses 502 of FIG. 5 and an implementation 600 of a mobile device 602, such as a phone or tablet, as illustrative, non-limiting examples. In a particular aspect, the glasses 502 correspond to an implementation of the glasses device 102 and the mobile device 602 corresponds to an implementation of the companion device 202 of FIG. 2.

The glasses 502 include the HVE 180, and optionally the image source 106. The mobile device 602 includes a display screen 604 and the image-based cognitive analyzer 146. The image-based cognitive analyzer 146 is illustrated using dashed lines to indicate an internal component that is not generally visible to a user of the mobile device 602. In a particular example, the image-based cognitive analyzer 146 detects the query 136, which is then processed to perform one or more operations at the mobile device 602, such as to launch a graphical user interface or otherwise display the response 138 at the display screen 604 (e.g., via an integrated “smart assistant” application).

The glasses 502 and the mobile device 602 perform one or more operations described with reference to the glasses device 102 and the companion device 202, respectively, of FIG. 2. For example, in some aspects, the glasses 502 obtain the image frames 112 from the image source 106 and use the HVE 180 to generate the sets of image latent data 122, as described with reference to the glasses device 102 of FIGS. 1A and 2. The glasses 502 transmit one or more of the sets of image latent data 122 to the mobile device 602. The mobile device 602, responsive to receiving the query 136, uses the image-based cognitive analyzer 146 to generate the response 138 based on one or more sets of image latent data 122 and outputs the response 138, as described with reference to the companion device 202 of FIG. 2.

FIG. 7 depicts the glasses 502 of FIG. 5 and an implementation 700 of a wearable electronic device 702, illustrated as a “smart watch.” In a particular aspect, the glasses 502 correspond to an implementation of the glasses device 102 and the wearable electronic device 702 corresponds to an implementation of the companion device 202 of FIG. 2.

The glasses 502 include the HVE 180, and optionally the image source 106. The wearable electronic device 702 includes the image-based cognitive analyzer 146. The glasses 502 and the wearable electronic device 702 perform one or more operations described with reference to the glasses device 102 and the companion device 202, respectively, of FIG. 2. For example, the glasses 502 obtain the image frames 112 from the image source 106 and use the HVE 180 to generate the sets of image latent data 122, as described with reference to the glasses device 102 of FIGS. 1A and 2. The glasses 502 transmit one or more of the sets of image latent data 122 to the mobile device 602. The mobile device 602, responsive to receiving the query 136, uses the image-based cognitive analyzer 146 to generate the response 138 based on one or more sets of image latent data 122 and outputs the response 138, as described with reference to the companion device 202 of FIG. 2.

In some examples, the image-based cognitive analyzer 146 operates to obtain the image latent data 122, the query 136, the response 138, or a combination thereof, which are then processed to perform one or more operations at the wearable electronic device 702, such as to launch a graphical user interface or otherwise display other information associated with the image latent data 122, the query 136, the response 138, or a combination thereof at a display screen 704 of the wearable electronic device 702.

In some aspects, the wearable electronic device 702 may include a display screen that is configured to display a notification based on obtaining the image latent data 122, the query 136, the response 138, or a combination thereof. In a particular example, the wearable electronic device 702 includes a haptic device that provides a haptic notification (e.g., vibrates) in response to obtaining the image latent data 122, the query 136, the response 138, or a combination thereof. For example, the haptic notification can cause a user to look at the wearable electronic device 702 to see a displayed notification indicating detection of the image latent data 122, the query 136, the response 138, or a combination thereof. The wearable electronic device 702 can thus alert a user with a hearing impairment or a user wearing a headset that the image latent data 122, the query 136, the response 138, or a combination thereof, are detected.

FIG. 8 depicts the glasses 502 of FIG. 5 and an implementation 800 of a wireless speaker and voice activated device 802. In a particular aspect, the glasses 502 correspond to an implementation of the glasses device 102 and the wireless speaker and voice activated device 802 corresponds to an implementation of the companion device 202 of FIG. 2.

The wireless speaker and voice activated device 802 can have wireless network connectivity and is configured to execute an assistant operation. The glasses 502 include the HVE 180, and optionally the image source 106. The image-based cognitive analyzer 146 is integrated into the wireless speaker and voice activated device 802. The wireless speaker and voice activated device 802 also includes a speaker 804.

The glasses 502 and the wireless speaker and voice activated device 802 perform one or more operations described with reference to the glasses device 102 and the companion device 202, respectively, of FIG. 2. For example, in some aspects, the glasses 502 obtain the image frames 112 from the image source 106 and use the HVE 180 to generate the sets of image latent data 122, as described with reference to the glasses device 102 of FIGS. 1A and 2. The glasses 502 transmit one or more of the sets of image latent data 122 to the wireless speaker and voice activated device 802. The wireless speaker and voice activated device 802, responsive to receiving the query 136, uses the image-based cognitive analyzer 146 to generate the response 138 based on one or more sets of image latent data 122 and outputs the response 138, as described with reference to the companion device 202 of FIG. 2.

During operation, in response to receiving a verbal command, the wireless speaker and voice activated device 802 can execute assistant operations, such as via execution of a voice activation system (e.g., an integrated assistant application). The assistant operations can include adjusting a temperature, playing music, turning on lights, etc. For example, the assistant operations are performed responsive to receiving a command after a keyword or key phrase (e.g., “hello assistant”). In an example, the assistant operations include generating the response 138 to the query 136, as described with reference to the companion device 202 of FIG. 2.

FIG. 9 depicts an implementation 900 of a portable electronic device that corresponds to a virtual reality, mixed reality, or augmented reality headset 902. In a particular aspect, the headset 902 corresponds to an implementation of the glasses device 102.

The HVE 180, the image-based cognitive analyzer 146, and optionally the image source 106, are included in the headset 902. The headset 902 performs one or more operations described with reference to the glasses device 102 of FIGS. 1A and 2. For example, the image source 106 may function to output the image frames 112, the HVE 180 may function to generate the image latent data 122, the image-based cognitive analyzer 146 may function to generate the response 138, or a combination thereof, as described with reference to FIGS. 1A and 2.

In some aspects, the headset 902 obtains the sequence of image frames 112 from the image source 106, generates the sets of image latent data 122, and sends the sets of image latent data 122 to another device (e.g., the mobile device 602 of FIG. 6, the wearable electronic device 702 of FIG. 7, the wireless speaker and voice activated device 802 of FIG. 8, or a combination thereof), as described with reference to the glasses device 102 of FIG. 2. The other device uses the image-based cognitive analyzer 146 to generate the response 138, as described with reference to the companion device 202 of FIG. 2. The headset 902, the other device, or both, output the response 138.

In an example, a visual interface device is positioned in front of the user's eyes to enable display of augmented reality, mixed reality, or virtual reality images or scenes to the user while the headset 902 is worn. In a particular example, the visual interface device is configured to display a notification indicating that image frames 112, the image latent data 122, the query 136, the response 138, or a combination thereof, are detected. In some examples, the visual interface is configured to display the response 138.

FIG. 10 depicts the glasses 502 of FIG. 5 and an implementation 1000 of a vehicle 1002, illustrated as a car. In a particular aspect, the glasses 502 correspond to an implementation of the glasses device 102 and the vehicle 1002 corresponds to an implementation of the companion device 202 of FIG. 2. In a particular aspect, the companion device 202 is integrated into the vehicle 1002.

The glasses 502 include the HVE 180, and optionally the image source 106. The vehicle 1002 includes the image-based cognitive analyzer 146. In some aspects, the vehicle 1002 includes a microphone 1022. The glasses 502 and the vehicle 1002 perform one or more operations described with reference to the glasses device 102 and the companion device 202, respectively, of FIG. 2. For example, in some aspects, the glasses 502 obtain the image frames 112 from the image source 106 and use the HVE 180 to generate the sets of image latent data 122, as described with reference to the glasses device 102 of FIGS. 1A and 2. The glasses 502 transmit one or more of the sets of image latent data 122 to the vehicle 1002. The vehicle 1002, responsive to receiving the query 136, uses the image-based cognitive analyzer 146 to generate the response 138 based on one or more sets of image latent data 122 and outputs the response 138, as described with reference to the companion device 202 of FIG. 2.

In some aspects, the query 136 may be detected based on audio signals received from the microphone 1022 of the vehicle 1002. In some implementations, query detection can be performed based on an audio signal received from interior microphones (e.g., the microphone 1022), such as for a voice query from an authorized passenger. In some implementations, query detection can be performed based on an audio signal received from external microphones (e.g., the microphone 1022), such as an authorized user of the vehicle. In a particular implementation, in response to receiving a verbal command, a voice activation system initiates one or more operations of the vehicle 1002 based on one or more keywords (e.g., “unlock,” “start engine,” “play music,” “display weather forecast,” or another voice command) detected in an audio signal, such as by providing feedback or information via a display 1020 or one or more speakers (e.g., a speaker 1010).

In some aspects, the vehicle 1002 receives the image latent data 122 from the glasses 502. In some examples, the vehicle 1002 uses the image-based cognitive analyzer 146 to process the image latent data 122 to generate the response 138 to the query 136, as described with reference to the companion device 202 of FIG. 2. In a particular aspect, the vehicle 1002 outputs the response 138 via the display 1020, the speaker 1010, or both.

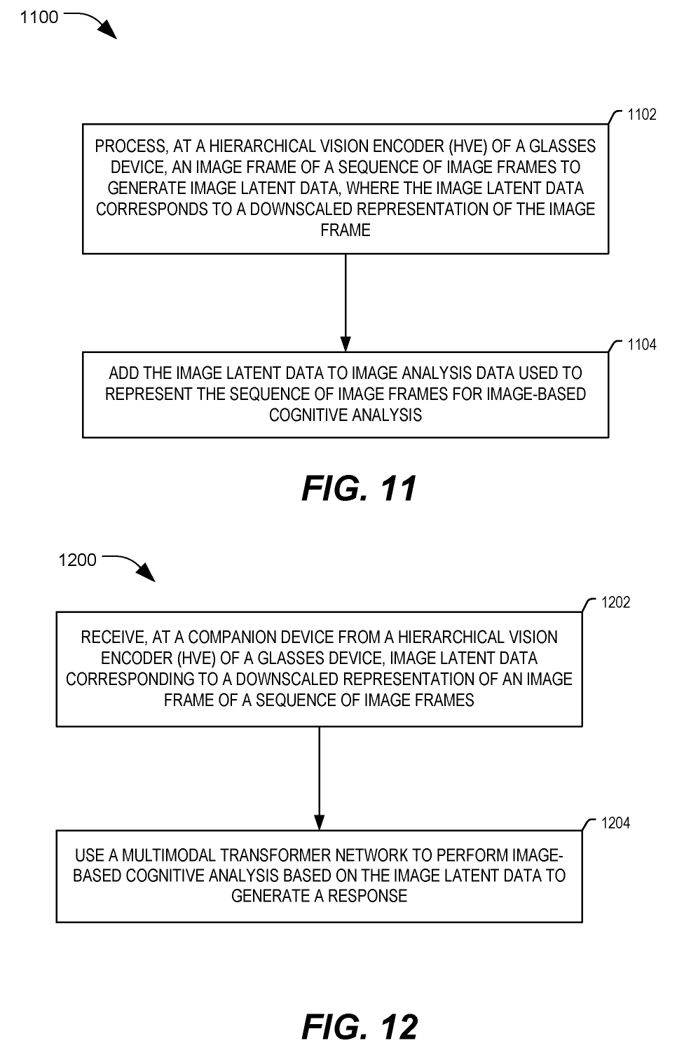

Referring to FIG. 11, a particular implementation of a method 1100 of performing hierarchical vision encoding enabled cognitive analysis is shown. In a particular aspect, one or more operations of the method 1100 are performed by at least one of the stages 140, the HVE 180, the one or more processors 190, the glasses device 102, the system 100 of FIG. 1A, the multi-context local attention(s) 160, the downscaling layer(s) 162 of FIG. 1B, the system 200 of FIG. 2, the integrated circuit 402 of FIG. 4, or a combination thereof.

The method 1100 includes, at 1102, processing, at a hierarchical vision encoder (HVE) of a glasses device, an image frame of a sequence of image frames to generate image latent data, where the image latent data corresponds to a downscaled representation of the image frame. For example, the HVE 180 of the glasses device 102 processes, the image frame 112A of the sequence of image frames 112 to generate the image latent data 122A, as described with reference to FIGS. 1A-2. The image latent data 122A corresponds to a downscaled representation of the image frame 112A.

The method 1100 includes, at 1104, adding the image latent data to image analysis data used to represent the sequence of image frames for image-based cognitive analysis. For example, the HVE 180 adds the image latent data 122A to the image analysis data 148 stored at the memory 132 of the glasses device 102, as described with reference to FIG. 1A. The image analysis data 148 is used to represent the sequence of image frames 112 for image-based cognitive analysis. As another example, the HVE 180 adds the image latent data 122A to the image analysis data 248 stored at the memory 232 of the companion device 202, as described with reference to FIG. 2. The image analysis data 248 is used to represent the sequence of image frames 112 for image-based cognitive analysis.

A technical advantage of the method 1100 includes accessibility to data associated with more image frames 112 for cognitive analysis. For example, the image latent data 122A is smaller than the image frame 112A. With limited storage capacity, sets of image latent data 122 corresponding to more image frames 112 can be stored in the memory 132 and the memory 232 than original image frames 112.

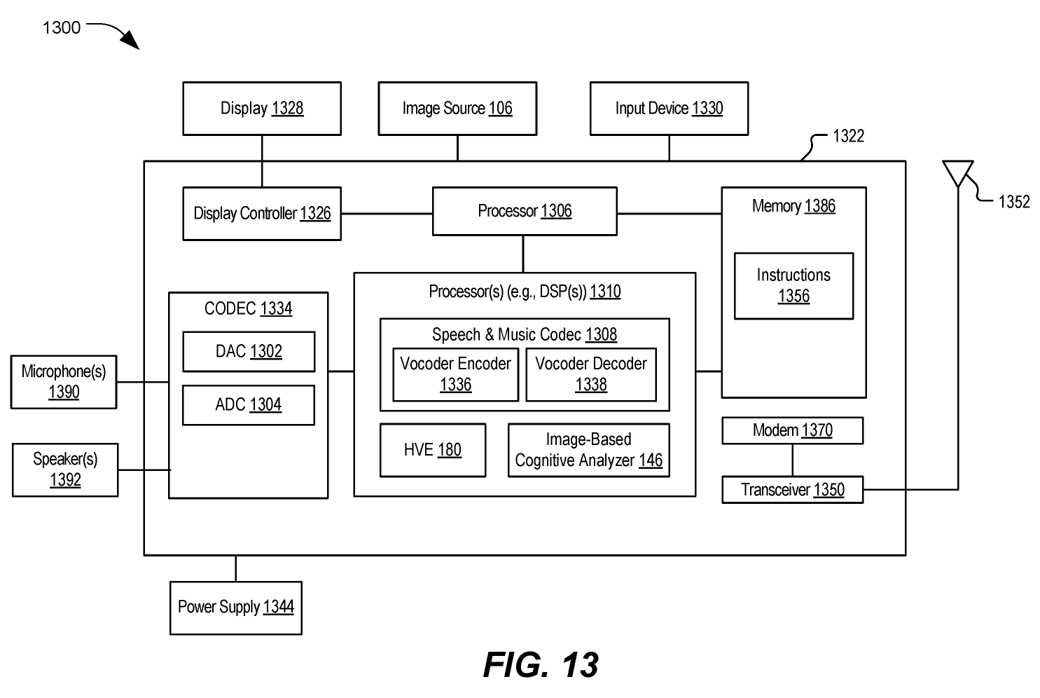

The method 1100 of FIG. 11 may be implemented by a FPGA device, an application-specific integrated circuit (ASIC), a processing unit such as a central processing unit (CPU), a digital signal processor (DSP), a controller, another hardware device, firmware device, or any combination thereof. As an example, the method 1100 of FIG. 11 may be performed by a processor that executes instructions, such as described with reference to FIG. 13.

Referring to FIG. 12, a particular implementation of a method 1200 of performing hierarchical vision encoding enabled cognitive analysis is shown. In a particular aspect, one or more operations of the method 1200 are performed by at least one of the image-based cognitive analyzer 146 of FIG. 1A, the one or more processors 290, the companion device 202, the system 200 of FIG. 2, the projector 340, the tokenizer 342, the embedding generator 344, the multimodal transformer network 346 of FIG. 3, the integrated circuit 402 of FIG. 4, or a combination thereof.

The method 1200 includes, at 1202, receiving, at a companion device from a hierarchical vision encoder (HVE) of a glasses device, image latent data corresponding to a downscaled representation of an image frame of a sequence of image frames. For example, the companion device 202 of FIG. 2 receives, from the glasses device 102, the image latent data 122A representing the image frame 112A, as described with reference to FIG. 2.

The method 1200 includes, at 1204, using a multimodal transformer network to perform image-based cognitive analysis based on the image latent data to generate a response. For example, the image-based cognitive analyzer 146 of the companion device 202 uses the multimodal transformer network 346 (e.g., an LLM) to perform image-based cognitive analysis based on the image latent data 122, as described with reference to FIGS. 2-3.

A technical advantage of the method 1200 includes offloading storage of the sets of image latent data 122 and performance of the image-based cognitive analysis from the glasses device 102 to the companion device 202. Hence, the glasses device 102 can be a relatively light-weight device, with the companion device 202 having more resources (e.g., more memory, computing resources, or both).

The method 1200 of FIG. 12 may be implemented by a FPGA device, an ASIC, a processing unit such as a CPU, a DSP, a controller, another hardware device, firmware device, or any combination thereof. As an example, the method 1200 of FIG. 12 may be performed by a processor that executes instructions, such as described with reference to FIG. 13.

Referring to FIG. 13, a block diagram of a particular illustrative implementation of a device is depicted and generally designated 1300. In various implementations, the device 1300 may have more or fewer components than illustrated in FIG. 13. In an illustrative implementation, the device 1300 may correspond to the glasses device 102, the companion device 202, or both. In an illustrative implementation, the device 1300 may perform one or more operations described with reference to FIGS. 1A-12.

In a particular implementation, the device 1300 includes a processor 1306 (e.g., a CPU). The device 1300 may include one or more additional processors 1310 (e.g., one or more DSPs). In a particular aspect, the one or more processors 190 of FIG. 1A, the one or more processors 290 of FIG. 2, the one or more processors 490 of FIG. 4, or a combination thereof, correspond to the processor 1306, the processors 1310, or a combination thereof. The processors 1310 may include a speech and music coder-decoder (CODEC) 1308 that includes a voice coder (“vocoder”) encoder 1336, a vocoder decoder 1338, or both. The processors 1310 include the HVE 180, the image-based cognitive analyzer 146, or both. Optionally, in some embodiments, the processors 1310 include the image source 106.

The device 1300 may include a memory 1386 and a CODEC 1334. The memory 1386 may include instructions 1356, that are executable by the one or more additional processors 1310 (or the processor 1306) to implement the functionality described with reference to one or more components of the HVE 180, the image-based cognitive analyzer 146, or both. The device 1300 may include a modem 1370 coupled, via a transceiver 1350, to an antenna 1352.

In a particular aspect, the modem 1370 is configured to transmit one or more sets of image latent data 122, receive one or more sets of image latent data 122, receive the query 136, transmit the query 136, receive the response 138, transmit the response 138, or a combination thereof. Optionally, in some embodiments, the modem 1370 is configured to receive the sequence of image frames 112 from the image source 106.

The device 1300 may include a display 1328 coupled to a display controller 1326. One or more speakers 1392, one or more microphones 1390, or a combination thereof may be coupled to the CODEC 1334. The CODEC 1334 may include a digital-to-analog converter (DAC) 1302, an analog-to-digital converter (ADC) 1304, or both. In a particular implementation, the CODEC 1334 may receive analog signals from the one or more microphones 1390, convert the analog signals to digital signals using the analog-to-digital converter 1304, and provide the digital signals to the speech and music codec 1308. The speech and music codec 1308 may process the digital signals. In a particular implementation, the speech and music codec 1308 may provide digital signals to the CODEC 1334. The CODEC 1334 may convert the digital signals to analog signals using the digital-to-analog converter 1302 and may provide the analog signals to the one or more speakers 1392.

In a particular implementation, the device 1300 may be included in a system-in-package or system-on-chip device 1322. In a particular implementation, the memory 1386, the processor 1306, the processors 1310, the display controller 1326, the CODEC 1334, and the modem 1370 are included in the system-in-package or system-on-chip device 1322. In a particular implementation, an input device 1330, a power supply 1344, and optionally the image source 106, are coupled to the system-in-package or the system-on-chip device 1322. Moreover, in a particular implementation, as illustrated in FIG. 13, the display 1328, the input device 1330, the one or more speakers 1392, the one or more microphones 1390, the antenna 1352, the power supply 1344, and optionally the image source 106, are external to the system-in-package or the system-on-chip device 1322. In a particular implementation, each of the display 1328, the input device 1330, the one or more speakers 1392, the one or more microphones 1390, the antenna 1352, the power supply 1344, and optionally the image source 106 may be coupled to a component of the system-in-package or the system-on-chip device 1322, such as an interface or a controller.

The device 1300 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an extended reality headset, an aerial vehicle, a home automation system, a voice-activated device, a wireless speaker and voice activated device, a portable electronic device, a car, a computing device, a communication device, an internet-of-things (IoT) device, a virtual reality (VR) device, an extended reality (XR) device, a base station, a mobile device, or any combination thereof.

In conjunction with the described implementations, an apparatus includes means for processing, at a hierarchical vision encoder (HVE) of a glasses device, an image frame of a sequence of image frames to generate image latent data, where the image latent data corresponds to a downscaled representation of the image frame. For example, the means for processing at the HVE of a glasses device can correspond to the stages 140, the HVE 180, the one or more processors 190, the glasses device 102, the system 100 of FIG. 1A, the multi-context local attention(s) 160, the downscaling layer(s) 162 of FIG. 1B, the system 200 of FIG. 2, the one or more processors 490, the integrated circuit 402 of FIG. 4, the processor 1306, the processor 1310, the device 1300 of FIG. 13, one or more other circuits or components configured to process an image frame 112 at the HVE 180 of a glasses device 102, or any combination thereof.

The apparatus further includes means for adding the image latent data to image analysis data used to represent the sequence of image frames for image-based cognitive analysis. For example, the means for adding can correspond to the stages 140, the HVE 180, the memory 132, the one or more processors 190, the glasses device 102, the system 100 of FIG. 1A, the multi-context local attention(s) 160, the downscaling layer(s) 162 of FIG. 1B, the memory 232, the companion device 202, the system 200 of FIG. 2, the one or more components 440, the one or more processors 490, the integrated circuit 402 of FIG. 4, the processor 1306, the processor 1310, the device 1300 of FIG. 13, one or more other circuits or components configured to add image latent data 122 to image analysis data 148 or add the image latent data 122 to the image analysis data 248, or any combination thereof.

Also in conjunction with the described implementations, an apparatus includes means for receiving, at a companion device from a hierarchical vision encoder (HVE) of a glasses device, first image latent data corresponding to a downscaled representation of a first image frame of a sequence of image frames. For example, the means for receiving can correspond to the memory 232, the companion device 202, the system 200 of FIG. 2, the one or more components 440, the one or more processors 490, the integrated circuit 402 of FIG. 4, the antenna 1352, the transceiver 1350, the modem 1370, the processor 1306, the processor 1310, the device 1300 of FIG. 13, one or more other circuits or components configured to receive image latent data 122 at the companion device 202, or any combination thereof.

The apparatus further includes means for using a multimodal transformer network to perform image-based cognitive analysis based on the first image latent data to generate a response. For example, the means for using can correspond to the image-based cognitive analyzer 146 of FIG. 1A, the companion device 202, the system 200 of FIG. 2, the projector 340, the tokenizer 342, the embedding generator 344, the multimodal transformer network 346 of FIG. 3, the one or more components 440, the one or more processors 490, the integrated circuit 402 of FIG. 4, the processor 1306, the processor 1310, the device 1300 of FIG. 13, one or more other circuits or components configured to use a multimodal transformer network, or any combination thereof.

In some implementations, a non-transitory computer-readable medium (e.g., a computer-readable storage device, such as the memory 1386) includes instructions (e.g., the instructions 1356) that, when executed by one or more processors (e.g., the one or more processors 1310 or the processor 1306), cause the one or more processors to process, at a hierarchical vision encoder (HVE) (e.g., the HVE 180) of a glasses device (e.g., the glasses device 102), an image frame (e.g., the image frame 112A) of a sequence of image frames (e.g., the image frames 112) to generate image latent data (e.g., the image latent data 122A). The image latent data corresponds to a downscaled representation of the image frame. The instructions further cause the one or more processors to add the image latent data to image analysis data (e.g., the image analysis data 148, the image analysis data 248, or both) used to represent the sequence of image frames for image-based cognitive analysis.

Also, in some implementations, a non-transitory computer-readable medium (e.g., a computer-readable storage device, such as the memory 1386) includes instructions (e.g., the instructions 1356) that, when executed by one or more processors (e.g., the one or more processors 1310 or the processor 1306), cause the one or more processors to receive, at a companion device (e.g., the companion device 202) from a hierarchical vision encoder (HVE) (e.g., the HVE 180) of a glasses device (e.g., the glasses device 102), image latent data (e.g., the image latent data 122A) representing an image frame (e.g., the image frame 112A) of a sequence of image frames (e.g., the image frames 112). The instructions further cause the one or more processors to use a multimodal transformer network (e.g., the multimodal transformer network 346) to perform image-based cognitive analysis based on the image latent data to generate a response (e.g., the response 138).

Particular aspects of the disclosure are described below in sets of interrelated Examples:

According to Example 1, a glasses device includes a memory configured to store one or more sets of image latent data; and one or more processors coupled to the memory and configured to process, at a hierarchical vision encoder (HVE), a first image frame of a sequence of image frames to generate first image latent data, wherein the first image latent data corresponds to a downscaled representation of the first image frame; and add the first image latent data to image analysis data used to represent the sequence of image frames for image-based cognitive analysis.

Example 2 includes the glasses device of Example 1, wherein the one or more processors are configured to perform the image-based cognitive analysis based on the first image latent data.

Example 3 includes the glasses device of Example 1 or Example 2, wherein the one or more processors are configured to generate image tokens based on the first image latent data; generate linguistic tokens based on a query; and use a large language model (LLM) to perform the image-based cognitive analysis based on the image tokens and the linguistic tokens to generate a response.

Example 4 includes the glasses device of any of Examples 1 to 3, wherein the first image latent data includes a plurality of image feature embeddings corresponding to the downscaled representation of the first image frame, and wherein the one or more processors are configured to generate linguistic tokens based on a query; generate first image tokens based on a first image feature embedding of the plurality of image feature embeddings; generate second image tokens based on a second image feature embedding of the plurality of image feature embeddings; generate a first input embedding based on the linguistic tokens and the first image tokens; generate a second input embedding based on the linguistic tokens and the second image tokens; and use a multimodal transformer network to perform the image-based cognitive analysis based on the first input embedding and the second input embedding to generate a response.

Example 5 includes the glasses device of any of Examples 1 to 4, wherein the one or more processors are configured to process, at the HVE, a second image frame of the sequence of image frames to generate second image latent data, wherein the second image latent data corresponds to a downscaled representation of the second image frame; and add the second image latent data to the image analysis data for the image-based cognitive analysis.

Example 6 includes the glasses device of Example 5, wherein the one or more processors are configured to generate linguistic tokens based on a query; generate first image tokens based on the first image latent data; generate second image tokens based on the second image latent data; and use a large language model (LLM) to perform the image-based cognitive analysis based on the linguistic tokens, the first image tokens, and the second image tokens to generate a response.

Example 7 includes the glasses device of any of Examples 1 to 6, wherein the one or more processors are configured to initiate transmission of the first image latent data to a companion device that performs the image-based cognitive analysis.

Example 8 includes the glasses device of any of Examples 1 to 7, wherein the one or more processors are configured to initiate transmission of the first image latent data to a companion device for the image-based cognitive analysis, wherein a multimodal transformer network is used to perform the image-based cognitive analysis based on image tokens and linguistic tokens to generate a response, and wherein the image tokens are based on the first image latent data.

Example 9 includes the glasses device of any of Examples 1 to 8, and further includes a modem coupled to the one or more processors and configured to initiate transmission of the first image latent data.

Example 10 includes the glasses device of any of Examples 1 to 9, and further includes a camera coupled to the one or more processors and configured to generate the sequence of image frames.

According to Example 11, a companion device includes a memory configured to store one or more sets of image latent data; and one or more processors coupled to the memory and configured to receive, from a hierarchical vision encoder (HVE) of a glasses device, first image latent data corresponding to a downscaled representation of a first image frame of a sequence of image frames; and use a multimodal transformer network to perform image-based cognitive analysis based on the first image latent data to generate a response.

Example 12 includes the companion device of Example 11, wherein the one or more processors are configured to generate image tokens based on the first image latent data; and generate linguistic tokens based on a query, wherein the multimodal transformer network is configured to perform the image-based cognitive analysis based on the image tokens and the linguistic tokens.

Example 13 includes the companion device of Example 11 or Example 12, wherein the first image latent data includes a plurality of image feature embeddings corresponding to the downscaled representation of the first image frame, and wherein the one or more processors are configured to generate linguistic tokens based on a query; generate first image tokens based on a first image feature embedding of the plurality of image feature embeddings; generate second image tokens based on a second image feature embedding of the plurality of image feature embeddings; generate a first input embedding based on the linguistic tokens and the first image tokens; generate a second input embedding based on the linguistic tokens and the second image tokens; and use the multimodal transformer network to perform the image-based cognitive analysis based on the first input embedding and the second input embedding to generate the response.

Example 14 includes the companion device of any of Examples 11 to 13, wherein the one or more processors are configured to receive, from the HVE of the glasses device, second image latent data corresponding to a downscaled representation of a second image frame of the sequence of image frames, and wherein the multimodal transformer network is configured to perform the image-based cognitive analysis based on the second image latent data.

Example 15 includes the companion device of Example 14, wherein the one or more processors are configured to generate linguistic tokens based on a query; generate first image tokens based on the first image latent data; and generate second image tokens based on the second image latent data, wherein the multimodal transformer network is configured to perform the image-based cognitive analysis based on the linguistic tokens, the first image tokens, and the second image tokens.

Example 16 includes the companion device of any of Examples 11 to 15, and further includes a modem coupled to the one or more processors and configured to receive the first image latent data.

Example 17 includes the companion device of any of Examples 11 to 16, and further includes a display device coupled to the one or more processors and configured to output the response.

According to Example 18, a method includes processing, at a hierarchical vision encoder (HVE) of a glasses device, a first image frame of a sequence of image frames to generate first image latent data, wherein the first image latent data corresponds to a downscaled representation of the first image frame; and adding the first image latent data to image analysis data used to represent the sequence of image frames for image-based cognitive analysis.

Example 19 includes the method of Example 18, further comprising performing the image-based cognitive analysis based on the first image latent data.

Example 20 includes the method of Example 18 or Example 19, further includes generating image tokens based on the first image latent data; generating linguistic tokens based on a query; and using a large language model (LLM) to perform the image-based cognitive analysis based on the image tokens and the linguistic tokens to generate a response.

Example 21 includes the method of any of Examples 18 to 20, wherein the first image latent data includes a plurality of image feature embeddings corresponding to the downscaled representation of the first image frame, and further includes generating linguistic tokens based on a query; generating first image tokens based on a first image feature embedding of the plurality of image feature embeddings; generating second image tokens based on a second image feature embedding of the plurality of image feature embeddings; generating a first input embedding based on the linguistic tokens and the first image tokens; generating a second input embedding based on the linguistic tokens and the second image tokens; and using a multimodal transformer network to perform the image-based cognitive analysis based on the first input embedding and the second input embedding to generate a response.

Example 22 includes the method of any of Examples 18 to 21, further includes processing, at the HVE, a second image frame of the sequence of image frames to generate second image latent data, wherein the second image latent data corresponds to a downscaled representation of the second image frame; and adding the second image latent data to the image analysis data for the image-based cognitive analysis.

Example 23 includes the method of Example 22, further includes generating linguistic tokens based on a query; generating first image tokens based on the first image latent data; generating second image tokens based on the second image latent data; and using a large language model (LLM) to perform the image-based cognitive analysis based on the linguistic tokens, the first image tokens, and the second image tokens to generate a response.

Example 24 includes the method of any of Examples 18 to 23, and further includes initiating transmission of the first image latent data to a companion device that performs the image-based cognitive analysis.

Example 25 includes the method of any of Examples 18 to 24, and further includes initiating transmission of the first image latent data to a companion device for the image-based cognitive analysis, wherein a multimodal transformer network is used to perform the image-based cognitive analysis based on image tokens and linguistic tokens to generate a response, and wherein the image tokens are based on the first image latent data.

Example 26 includes the method of any of Examples 18 to 25, and further includes initiating, using a modem, transmission of the first image latent data.

Example 27 includes the method of any of Examples 18 to 26, and further includes receiving the sequence of image frames from a camera.

According to Example 28, a method includes receiving, at a companion device from a hierarchical vision encoder (HVE) of a glasses device, first image latent data corresponding to a downscaled representation of a first image frame of a sequence of image frames; and using a multimodal transformer network to perform image-based cognitive analysis based on the first image latent data to generate a response.

Example 29 includes the method of Example 28, further includes generating image tokens based on the first image latent data; and generating linguistic tokens based on a query, wherein the multimodal transformer network is configured to perform the image-based cognitive analysis based on the image tokens and the linguistic tokens.

Example 30 includes the method of Example 28 or Example 29, wherein the first image latent data includes a plurality of image feature embeddings corresponding to the downscaled representation of the first image frame, and further includes generating linguistic tokens based on a query; generating first image tokens based on a first image feature embedding of the plurality of image feature embeddings; generating second image tokens based on a second image feature embedding of the plurality of image feature embeddings; generating a first input embedding based on the linguistic tokens and the first image tokens; generating a second input embedding based on the linguistic tokens and the second image tokens; and using the multimodal transformer network to perform the image-based cognitive analysis based on the first input embedding and the second input embedding to generate the response.

Example 31 includes the method of any of Examples 28 to 30, and further includes receiving, from the HVE of the glasses device, second image latent data corresponding to a downscaled representation of a second image frame of the sequence of image frames, and wherein the multimodal transformer network is configured to perform the image-based cognitive analysis based on the second image latent data.

Example 32 includes the method of Example 31, further includes generating linguistic tokens based on a query; generating first image tokens based on the first image latent data; and generating second image tokens based on the second image latent data, wherein the multimodal transformer network is configured to perform the image-based cognitive analysis based on the linguistic tokens, the first image tokens, and the second image tokens.

Example 33 includes the method of any of Examples 28 to 32, and further includes receiving, via a modem, the first image latent data.

Example 34 includes the method of any of Examples 28 to 33, and further includes outputting the response to a display device.

According to Example 35, a non-transitory computer-readable medium storing instructions that, when executed by one or more processors, cause the one or more processors to process, at a hierarchical vision encoder (HVE) of a glasses device, a first image frame of a sequence of image frames to generate first image latent data, wherein the first image latent data corresponds to a downscaled representation of the first image frame; and add the first image latent data to image analysis data used to represent the sequence of image frames for image-based cognitive analysis.

Example 36 includes the non-transitory computer-readable medium of Example 35, wherein the instructions, when executed by one or more processors, cause the one or more processors to perform the image-based cognitive analysis based on the first image latent data.

Example 37 includes the non-transitory computer-readable medium of Example 35 or Example 36, wherein the instructions, when executed by one or more processors, cause the one or more processors to generate image tokens based on the first image latent data; generate linguistic tokens based on a query; and use a large language model (LLM) to perform the image-based cognitive analysis based on the image tokens and the linguistic tokens to generate a response.

Example 38 includes the non-transitory computer-readable medium of any of Examples 35 to 37, wherein the first image latent data includes a plurality of image feature embeddings corresponding to the downscaled representation of the first image frame, and wherein the instructions, when executed by one or more processors, cause the one or more processors to generate linguistic tokens based on a query; generate first image tokens based on a first image feature embedding of the plurality of image feature embeddings; generate second image tokens based on a second image feature embedding of the plurality of image feature embeddings; generate a first input embedding based on the linguistic tokens and the first image tokens; generate a second input embedding based on the linguistic tokens and the second image tokens; and use a multimodal transformer network to perform the image-based cognitive analysis based on the first input embedding and the second input embedding to generate a response.

Example 39 includes the non-transitory computer-readable medium of any of Examples 35 to 38, wherein the instructions, when executed by one or more processors, cause the one or more processors to: process, at the HVE, a second image frame of the sequence of image frames to generate second image latent data, wherein the second image latent data corresponds to a downscaled representation of the second image frame; and add the second image latent data to the image analysis data for the image-based cognitive analysis.

Example 40 includes the non-transitory computer-readable medium of Example 39, wherein the instructions, when executed by one or more processors, cause the one or more processors to generate linguistic tokens based on a query; generate first image tokens based on the first image latent data; generate second image tokens based on the second image latent data; and use a large language model (LLM) to perform the image-based cognitive analysis based on the linguistic tokens, the first image tokens, and the second image tokens to generate a response.

Example 41 includes the non-transitory computer-readable medium of any of Examples 35 to 40, wherein the instructions, when executed by one or more processors, cause the one or more processors to initiate transmission of the first image latent data to a companion device that performs the image-based cognitive analysis.

Example 42 includes the non-transitory computer-readable medium of any of Examples 35 to 41, wherein the instructions, when executed by one or more processors, cause the one or more processors to initiate transmission of the first image latent data to a companion device for the image-based cognitive analysis, wherein a multimodal transformer network is used to perform the image-based cognitive analysis based on image tokens and linguistic tokens to generate a response, and wherein the image tokens are based on the first image latent data.

Example 43 includes the non-transitory computer-readable medium of any of Examples 35 to 42, wherein the instructions, when executed by one or more processors, cause the one or more processors to initiate, using a modem, transmission of the first image latent data.

Example 44 includes the non-transitory computer-readable medium of any of Examples 35 to 43, wherein the instructions, when executed by one or more processors, cause the one or more processors to receive the sequence of image frames from a camera.

According to Example 45, a non-transitory computer-readable medium storing instructions that, when executed by one or more processors, cause the one or more processors to receive, at a companion device from a hierarchical vision encoder (HVE) of a glasses device, first image latent data corresponding to a downscaled representation of a first image frame of a sequence of image frames; and use a multimodal transformer network to perform image-based cognitive analysis based on the first image latent data to generate a response.

Example 46 includes the non-transitory computer-readable medium of Example 45, wherein the instructions, when executed by one or more processors, cause the one or more processors to generate image tokens based on the first image latent data; and generate linguistic tokens based on a query, wherein the multimodal transformer network is configured to perform the image-based cognitive analysis based on the image tokens and the linguistic tokens.

Example 47 includes the non-transitory computer-readable medium of Example 45 or Example 46, wherein the first image latent data includes a plurality of image feature embeddings corresponding to the downscaled representation of the first image frame, and wherein the instructions, when executed by one or more processors, cause the one or more processors to generate linguistic tokens based on a query; generate first image tokens based on a first image feature embedding of the plurality of image feature embeddings; generate second image tokens based on a second image feature embedding of the plurality of image feature embeddings; generate a first input embedding based on the linguistic tokens and the first image tokens; generate a second input embedding based on the linguistic tokens and the second image tokens; and use the multimodal transformer network to perform the image-based cognitive analysis based on the first input embedding and the second input embedding to generate the response.

Example 48 includes the non-transitory computer-readable medium of any of Examples 45 to 47, wherein the instructions, when executed by one or more processors, cause the one or more processors to receive, from the HVE of the glasses device, second image latent data corresponding to a downscaled representation of a second image frame of the sequence of image frames, and wherein the multimodal transformer network is configured to perform the image-based cognitive analysis based on the second image latent data.

Example 49 includes the non-transitory computer-readable medium of Example 48, wherein the instructions, when executed by one or more processors, cause the one or more processors to generate linguistic tokens based on a query; generate first image tokens based on the first image latent data; and generate second image tokens based on the second image latent data, wherein the multimodal transformer network is configured to perform the image-based cognitive analysis based on the linguistic tokens, the first image tokens, and the second image tokens.

Example 50 includes the non-transitory computer-readable medium of any of Examples 45 to 49, wherein the instructions, when executed by one or more processors, cause the one or more processors to receive, via a modem, the first image latent data.

Example 51 includes the non-transitory computer-readable medium of any of Examples 45 to 50, wherein the instructions, when executed by one or more processors, cause the one or more processors to output the response to a display device.

According to Example 52, an apparatus includes means for processing, at a hierarchical vision encoder (HVE) of a glasses device, a first image frame of a sequence of image frames to generate first image latent data, wherein the first image latent data corresponds to a downscaled representation of the first image frame; and means for adding the first image latent data to image analysis data used to represent the sequence of image frames for image-based cognitive analysis.

Example 53 includes the apparatus of Example 52, further comprising means for performing the image-based cognitive analysis based on the first image latent data.

Example 54 includes the apparatus of Example 52 or Example 53, further includes means for generating image tokens based on the first image latent data; means for generating linguistic tokens based on a query; and means for using a large language model (LLM) to perform the image-based cognitive analysis based on the image tokens and the linguistic tokens to generate a response.

Example 55 includes the apparatus of any of Examples 52 to 54, wherein the first image latent data includes a plurality of image feature embeddings corresponding to the downscaled representation of the first image frame, and the apparatus further includes means for generating linguistic tokens based on a query; means for generating first image tokens based on a first image feature embedding of the plurality of image feature embeddings; means for generating second image tokens based on a second image feature embedding of the plurality of image feature embeddings; means for generating a first input embedding based on the linguistic tokens and the first image tokens; means for generating a second input embedding based on the linguistic tokens and the second image tokens; and means for using a multimodal transformer network to perform the image-based cognitive analysis based on the first input embedding and the second input embedding to generate a response.

Example 56 includes the apparatus of any of Examples 52 to 55, further includes means for processing, at the HVE, a second image frame of the sequence of image frames to generate second image latent data, wherein the second image latent data corresponds to a downscaled representation of the second image frame; and means for adding the second image latent data to the image analysis data for the image-based cognitive analysis.

Example 57 includes the apparatus of Example 56, further includes means for generating linguistic tokens based on a query; means for generating first image tokens based on the first image latent data; means for generating second image tokens based on the second image latent data; and means for using a large language model (LLM) to perform the image-based cognitive analysis based on the linguistic tokens, the first image tokens, and the second image tokens to generate a response.

Example 58 includes the apparatus of any of Examples 52 to 55, and further includes means for initiating transmission of the first image latent data to a companion device that performs the image-based cognitive analysis.

Example 59 includes the apparatus of any of Examples 52 to 58, and further includes means for initiating transmission of the first image latent data to a companion device for the image-based cognitive analysis, wherein a multimodal transformer network is used to perform the image-based cognitive analysis based on image tokens and linguistic tokens to generate a response, and wherein the image tokens are based on the first image latent data.

Example 60 includes the apparatus of any of Examples 52 to 59, and further includes means for initiating, using a modem, transmission of the first image latent data.

Example 61 includes the apparatus of any of Examples 52 to 60, and further includes means for receiving the sequence of image frames from a camera.

According to Example 62, an apparatus includes means for receiving, at a companion device from a hierarchical vision encoder (HVE) of a glasses device, first image latent data corresponding to a downscaled representation of a first image frame of a sequence of image frames; and means for using a multimodal transformer network to perform image-based cognitive analysis based on the first image latent data to generate a response.

Example 63 includes the apparatus of Example 62, further includes means for generating image tokens based on the first image latent data; and means for generating linguistic tokens based on a query, wherein the multimodal transformer network is configured to perform the image-based cognitive analysis based on the image tokens and the linguistic tokens.

Example 64 includes the apparatus of Example 62 or Example 63, wherein the first image latent data includes a plurality of image feature embeddings corresponding to the downscaled representation of the first image frame, and the apparatus further includes means for generating linguistic tokens based on a query; means for generating first image tokens based on a first image feature embedding of the plurality of image feature embeddings; means for generating second image tokens based on a second image feature embedding of the plurality of image feature embeddings; means for generating a first input embedding based on the linguistic tokens and the first image tokens; means for generating a second input embedding based on the linguistic tokens and the second image tokens; and means for using the multimodal transformer network to perform the image-based cognitive analysis based on the first input embedding and the second input embedding to generate the response.

Example 65 includes the apparatus of any of Examples 62 to 64, and further includes means for receiving, from the HVE of the glasses device, second image latent data corresponding to a downscaled representation of a second image frame of the sequence of image frames, and wherein the multimodal transformer network is configured to perform the image-based cognitive analysis based on the second image latent data.

Example 66 includes the apparatus of Example 65, further includes means for generating linguistic tokens based on a query; means for generating first image tokens based on the first image latent data; and means for generating second image tokens based on the second image latent data, wherein the multimodal transformer network is configured to perform the image-based cognitive analysis based on the linguistic tokens, the first image tokens, and the second image tokens.

Example 67 includes the apparatus of any of Examples 62 to 66, and further includes means for receiving, using a modem, the first image latent data.

Example 68 includes the apparatus of any of Examples 62 to 67, and further includes means for outputting the response to a display device.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A glasses device comprising:
a memory configured to store one or more sets of image latent data; and
one or more processors coupled to the memory and configured to:
process, at a hierarchical vision encoder (HVE), a first image frame of a sequence of image frames to generate first image latent data, wherein the first image latent data corresponds to a downscaled representation of the first image frame; and
add the first image latent data to image analysis data used to represent the sequence of image frames for image-based cognitive analysis.

2. The glasses device of claim 1, wherein the one or more processors are configured to perform the image-based cognitive analysis based on the first image latent data.

3. The glasses device of claim 1, wherein the one or more processors are configured to:
generate image tokens based on the first image latent data;
generate linguistic tokens based on a query; and
use a large language model (LLM) to perform the image-based cognitive analysis based on the image tokens and the linguistic tokens to generate a response.

4. The glasses device of claim 1, wherein the first image latent data includes a plurality of image feature embeddings corresponding to the downscaled representation of the first image frame, and wherein the one or more processors are configured to:
generate linguistic tokens based on a query;
generate first image tokens based on a first image feature embedding of the plurality of image feature embeddings;
generate second image tokens based on a second image feature embedding of the plurality of image feature embeddings;
generate a first input embedding based on the linguistic tokens and the first image tokens;
generate a second input embedding based on the linguistic tokens and the second image tokens; and
use a multimodal transformer network to perform the image-based cognitive analysis based on the first input embedding and the second input embedding to generate a response.

5. The glasses device of claim 1, wherein the one or more processors are configured to:
process, at the HVE, a second image frame of the sequence of image frames to generate second image latent data, wherein the second image latent data corresponds to a downscaled representation of the second image frame; and
add the second image latent data to the image analysis data for the image-based cognitive analysis.

6. The glasses device of claim 5, wherein the one or more processors are configured to:
generate linguistic tokens based on a query;
generate first image tokens based on the first image latent data;
generate second image tokens based on the second image latent data; and
use a large language model (LLM) to perform the image-based cognitive analysis based on the linguistic tokens, the first image tokens, and the second image tokens to generate a response.

7. The glasses device of claim 1, wherein the one or more processors are configured to initiate transmission of the first image latent data to a companion device that performs the image-based cognitive analysis.

8. The glasses device of claim 1, wherein the one or more processors are configured to initiate transmission of the first image latent data to a companion device for the image-based cognitive analysis, wherein a multimodal transformer network is used to perform the image-based cognitive analysis based on image tokens and linguistic tokens to generate a response, and wherein the image tokens are based on the first image latent data.

9. The glasses device of claim 1, further comprising a modem coupled to the one or more processors and configured to initiate transmission of the first image latent data.

10. The glasses device of claim 1, further comprising a camera coupled to the one or more processors and configured to generate the sequence of image frames.

11. A companion device comprising:
a memory configured to store one or more sets of image latent data; and
one or more processors coupled to the memory and configured to:
receive, from a hierarchical vision encoder (HVE) of a glasses device, first image latent data corresponding to a downscaled representation of a first image frame of a sequence of image frames; and
use a multimodal transformer network to perform image-based cognitive analysis based on the first image latent data to generate a response.

12. The companion device of claim 11, wherein the one or more processors are configured to:
generate image tokens based on the first image latent data; and
generate linguistic tokens based on a query,
wherein the multimodal transformer network is configured to perform the image-based cognitive analysis based on the image tokens and the linguistic tokens.

13. The companion device of claim 11, wherein the first image latent data includes a plurality of image feature embeddings corresponding to the downscaled representation of the first image frame, and wherein the one or more processors are configured to:
generate linguistic tokens based on a query;
generate first image tokens based on a first image feature embedding of the plurality of image feature embeddings;
generate second image tokens based on a second image feature embedding of the plurality of image feature embeddings;
generate a first input embedding based on the linguistic tokens and the first image tokens;
generate a second input embedding based on the linguistic tokens and the second image tokens; and
use the multimodal transformer network to perform the image-based cognitive analysis based on the first input embedding and the second input embedding to generate the response.

14. The companion device of claim 11, wherein the one or more processors are configured to receive, from the HVE of the glasses device, second image latent data corresponding to a downscaled representation of a second image frame of the sequence of image frames, and wherein the multimodal transformer network is configured to perform the image-based cognitive analysis based on the second image latent data.

15. The companion device of claim 14, wherein the one or more processors are configured to:
generate linguistic tokens based on a query;
generate first image tokens based on the first image latent data; and
generate second image tokens based on the second image latent data,
wherein the multimodal transformer network is configured to perform the image-based cognitive analysis based on the linguistic tokens, the first image tokens, and the second image tokens.

16. The companion device of claim 11, further comprising a modem coupled to the one or more processors and configured to receive the first image latent data.

17. The companion device of claim 11, further comprising a display device coupled to the one or more processors and configured to output the response.

18. A method comprising:
processing, at a hierarchical vision encoder (HVE) of a glasses device, a first image frame of a sequence of image frames to generate first image latent data, wherein the first image latent data corresponds to a downscaled representation of the first image frame; and
adding the first image latent data to image analysis data used to represent the sequence of image frames for image-based cognitive analysis.

19. The method of claim 18, further comprising performing the image-based cognitive analysis based on the first image latent data.

20. The method of claim 18, further comprising:
generating image tokens based on the first image latent data;
generating linguistic tokens based on a query; and
using a large language model (LLM) to perform the image-based cognitive analysis based on the image tokens and the linguistic tokens to generate a response.

21. The method of claim 18, wherein the first image latent data includes a plurality of image feature embeddings corresponding to the downscaled representation of the first image frame, and further comprising:
generating linguistic tokens based on a query;
generating first image tokens based on a first image feature embedding of the plurality of image feature embeddings;
generating second image tokens based on a second image feature embedding of the plurality of image feature embeddings;
generating a first input embedding based on the linguistic tokens and the first image tokens;
generating a second input embedding based on the linguistic tokens and the second image tokens; and
using a multimodal transformer network to perform the image-based cognitive analysis based on the first input embedding and the second input embedding to generate a response.

22. The method of claim 18, further comprising:
processing, at the HVE, a second image frame of the sequence of image frames to generate second image latent data, wherein the second image latent data corresponds to a downscaled representation of the second image frame; and
adding the second image latent data to the image analysis data for the image-based cognitive analysis.

23. The method of claim 22, further comprising:
generating linguistic tokens based on a query;
generating first image tokens based on the first image latent data;
generating second image tokens based on the second image latent data; and
using a large language model (LLM) to perform the image-based cognitive analysis based on the linguistic tokens, the first image tokens, and the second image tokens to generate a response.

24. The method of claim 18, further comprising initiating transmission of the first image latent data to a companion device that performs the image-based cognitive analysis.

25. The method of claim 18, further comprising initiating transmission of the first image latent data to a companion device for the image-based cognitive analysis, wherein a multimodal transformer network is used to perform the image-based cognitive analysis based on image tokens and linguistic tokens to generate a response, and wherein the image tokens are based on the first image latent data.

26. The method of claim 18, further comprising initiating, using a modem, transmission of the first image latent data.

27. The method of claim 18, further comprising receiving the sequence of image frames from a camera.

28. A method comprising:
receiving, at a companion device from a hierarchical vision encoder (HVE) of a glasses device, first image latent data corresponding to a downscaled representation of a first image frame of a sequence of image frames; and
using a multimodal transformer network to perform image-based cognitive analysis based on the first image latent data to generate a response.

29. The method of claim 28, further comprising:
generating image tokens based on the first image latent data; and
generating linguistic tokens based on a query,
wherein the multimodal transformer network is configured to perform the image-based cognitive analysis based on the image tokens and the linguistic tokens.

30. The method of claim 28, wherein the first image latent data includes a plurality of image feature embeddings corresponding to the downscaled representation of the first image frame, and further comprising:
generating linguistic tokens based on a query;
generating first image tokens based on a first image feature embedding of the plurality of image feature embeddings;
generating second image tokens based on a second image feature embedding of the plurality of image feature embeddings;
generating a first input embedding based on the linguistic tokens and the first image tokens;
generating a second input embedding based on the linguistic tokens and the second image tokens; and
using the multimodal transformer network to perform the image-based cognitive analysis based on the first input embedding and the second input embedding to generate the response.
